(19) United States
(12) Patent Application Publication
(10) Pub. No.: US 2015/0235001 A1
(43) Pub. Date: Aug. 20, 2015

(54) System and Method for Scoring Health Related Risk

(71) Applicant: MedeAnalytics, Inc., Emeryville, CA (US)

(72) Inventor: Terry Fouts, Larkspur, CO (US)

(21) Appl. No.: 14/480,453

(22) Filed: Sep. 8, 2014

Related U.S. Application Data
(60) Provisional application No. 62/040,070, filed on Aug. 21, 2014.
(60) Provisional application No. 61/941,954, filed on Feb. 19, 2014.

(51) Int. Cl. G06F 19/00

(52) U.S. Cl. CPC G06F 19/3431

(57) ABSTRACT

Methods and systems are provided for assigning an individual to a stratum associated with a risk of generating a high level of health care-related costs. An electronic device receives information on the diagnosis of a medical condition for the individual. The device then identifies a gap in the individual's medical care for the diagnosed medical condition and associates the gap with an indexed value related to the severity of the gap in care. The device then assigns the individual to one of a plurality of strata based on a health care profile of the individual, where the health care profile includes the indexed value related to the severity of the gap in care.

### RELATED APPLICATIONS

This application claims priority to U.S. Provisional Application Ser. No. 62/040,070, filed Aug. 21, 2014 and U.S. Provisional Application Ser. No. 61/941,954, filed Feb. 19, 2014, both of which are incorporated herein by reference in their entirety.

### TECHNICAL FIELD

The disclosed implementations relate generally to methods and electronic systems for health care management. More specifically, the present disclosure relates to stratifying risks in a population of patients by identifying metrics associated with high levels of health care costs, such as gaps in a patient's health care.

### BACKGROUND

The generation of health care-related costs (e.g., insurance or managed care expenses incurred through medical usage) is distributed unevenly throughout a population of users, for example, a set of individual enrolled in a particular medical insurance plan or managed health care program. Generally, a vast majority of the medical expenses, within an insurance plan or managed health care program, are generated by a minority of the members enrolled in the medical plan or program. It is, thus, advantageous to stratify these populations to identify those individuals who pose the greatest likelihood of generating high levels of health care-related expenses (e.g., relative to the other individuals in the plan or program). Once identified, preemptive measures may be taken to improve the health of these at risk individuals. At the same time, allocation of preemptive medical resources will serve to lower the risk of these individuals accruing high levels of health care-related expenses.

There is, thus, a need to identify members of a health care population (e.g., an insurance group or managed health care group) who would most benefit from preemptive resources (e.g., access to case managers or other outreach program). In view of the limited resources available to heath care organizations, it is important that the best candidates are identified.

Likewise, insurance underwriters have a need for assigning individuals to an appropriate stratum (e.g., classification tier) associated with a relative risk of generating a high level of health care-related costs. In order for the underwriter to calculate an appropriate premium for an individual or group, the individual's relative risk is determined. In this fashion, the underwriter ensures that the total amount paid in premiums for an insurance plan (or managed health care program) is sufficient for operation of the medical coverage required of the group. This type of analysis is also important for evaluating the overall disease burden of an insured group of individuals.

Traditionally, models used to identify high risk individuals have focused on health care metrics such as chronic disease and past insurance/provider utilization. For example, U.S. Patent Application Publication No. 2001/0020229 proposes the generation of a predictive model based on past medical claims data for identifying individuals having a relatively high likelihood of using a disproportionately high amount of medical services. This model, however, does not account for individuals who have largely ignored their health care needs in the past. In contrast to individuals with high prior usage of medical resources, who may actually avoid disproportionately high future medical usage because of their diligence in treating and/or managing medical conditions in the past, individuals who ignore their medical needs may suffer from more advanced medical conditions because of their inactivity. For example, an individual who ignores a first signal of skin cancer may not see a health care professional until after the cancer has progressed to a point at which it has metastasized. As such, their eventual health care needs, once they actually consult a doctor, will be much more expensive than an individual who consults their doctor immediately. The latter's condition may be treated, for example, by resection of an initial abnormal growth on their skin. In contrast, the former's condition may require expensive radiation and/or chemotherapy.

In fact, these traditional approaches for identifying high risk individuals are inherently biased against individuals with gaps in their medical care. As such, it would be beneficial to provide systems and methods for stratifying individuals based on their likelihood of generating high levels of future health care-related costs, which account for gaps in an individual's past medical care.

### SUMMARY

Methods for identifying individuals having relatively high risks of generation of significant health care-related costs rely on metrics such as risks for developing chronic medical conditions and past utilization of heath care resources. These methods, however, do not provide accurate assessments of an individual's true risk because they ignore factors that contribute to future health care utilization, such as gaps in past medical care.

Accordingly, there is a need for systems and methods that provide more accurate stratification of patients in a health care population (e.g., an insurance plan or managed health care group). Such methods and systems may complement or replace conventional methods for stratifying individuals based on their risk of generating high levels of health care-related expenses. Such methods and systems will allow for more accurate planning of health care-related expenditures within a patient population, thereby reducing the overall cost of providing health care services. Such methods and systems will also allow for more efficient allocation of preemptive medical resources to assist those individuals at greatest risk.

To satisfy these and other needs, methods and systems are provided here that identify and account for gaps in an individual's medical care when assigning a relative risk of generation of high levels of health care-related costs (e.g., when stratifying individuals based on their relative risks). In some implementations, a gap in an individual's medical care is a lack of a medical provision that should have been provided. Non-limiting examples of such medical provisions include, a diagnosis that should have been made by a medical professional, a medical prescription that should have been given for a diagnosed or undiagnosed medical condition, a therapy that should have been assigned for a diagnosed or undiagnosed medical condition, or a lifestyle recommendation that should have been given for a diagnosed or undiagnosed medical condition.

In some implementations, systems and methods are provided for assigning an individual to a stratum (e.g., classification tier) associated with a risk of generating a high level of health care-related costs.

In accordance with some implementations, a method is performed at an electronic device with a processor and memory storing instructions for execution by the processor. The method includes receiving information on the diagnosis of a medical condition for the individual. The method then includes identifying a gap in the individual's medical care for the diagnosed medical condition. The method further includes associating the gap in medical care with an indexed value related to the severity of the gap in care. Finally, the method includes assigning the individual to one of a plurality of strata based on a health care profile of the individual, the health care profile comprising the indexed value related to the severity of the gap in care.

In some implementations, systems and methods are provided for assigning individuals in a set of individuals to a stratum associated with a risk of generating a high level of health care-related costs.

In accordance with some implementations, a method is performed at an electronic device with a processor and memory storing instructions for execution by the processor. The method includes receiving a plurality of medical histories, each medical history in the plurality of medical histories corresponding to an individual in the set of individuals, where respective medical histories in the plurality of medical histories include information on the diagnosis of a medical condition for the corresponding individual. The method also includes identifying gaps in the medical care of respective individuals for their corresponding medical conditions. The method then includes associating each respective gap in medical care with an indexed value related to the severity of the respective gap in medical care. The method finally includes assigning respective individuals in the set of individuals to one of a plurality of strata based on corresponding health care profiles, each respective health care profile comprising an indexed value related to the severity of the respective gap in care.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods described herein.

In accordance with some implementations, an electronic device is provided that comprises means for performing any of the methods described herein.

In accordance with some implementations, an electronic device is provided that comprises a processing unit configured to perform any of the methods described herein.

In accordance with some implementations, an electronic device is provided that comprises one or more processors and memory storing one or more programs for execution by the one or more processors, the one or more programs including instructions for performing any of the methods described herein.

In accordance with some implementations, an information processing apparatus for use in an electronic device is provided, the information processing apparatus comprising means for performing any of the methods described herein.

### BRIEF DESCRIPTION OF THE DRAWINGS

FIG. 1 is a block diagram illustrating an electronic device in accordance with some implementations.

FIG. 2 is an example of a distributed risk stratification environment in accordance with some implementations.

FIGS. 3A-3B are flow diagrams illustrating a method of scoring an individual's health care risk in accordance with some implementations.

FIGS. 4A-4C are flow diagrams illustrating a method for stratifying the health care risks of a population of individuals in accordance with some embodiments.

FIG. 5 is a flow chart illustrating exemplary processing steps for scoring an individual's health care risk in accordance with some implementations.

FIG. 6 is a flow chart illustrating exemplary processing steps for determining an aggregate indexed value associated with gaps in an individual's medical care.

FIG. 7 is a flow chart illustrating exemplary processing steps for estimating a date on which a diagnosed medical condition first began.

### DESCRIPTION OF IMPLEMENTATIONS

In some implementations, the disclosure relates to the identification of a gap in an individual's medical care. As used herein, a “gap in an individual's medical care,” or “gap in care,” refers to a lack of a recommended medical provision that was not provided to the individual. Non-limiting examples of such medical provisions include, a diagnosis that should have been made by a medical professional, a medical prescription that should have been given for a diagnosed or undiagnosed medical condition, a therapy that should have been assigned for a diagnosed or undiagnosed medical condition, a medical consultation that should have occurred, or a lifestyle recommendation that should have been given for a diagnosed or undiagnosed medical condition.

In some implementations, this is accomplished by identifying a recommended medical event that did not occur. For example, in some implementations, this occurs when an individual with a medical condition is not diagnosed for the condition during a medical consultation or fails to seek out medical attention. Likewise, in some implementations, this occurs when an individual with a medical condition, diagnosed or otherwise, is not prescribed a therapy (e.g., a pharmaceutical agent, dietary consideration, or lifestyle change) recommended for treatment of the condition. In some implementations, this occurs when an individual fails to attend a medical consultation recommended by a medical professional (e.g., an appointment with a specialist, a follow-up appointment, or a regularly scheduled physical examination).

In some implementations, a gap in medical care is identified by reviewing available medical records for an individual and determining a period of time that corresponds to a gap in the individual's medical care. In some implementations, this is accomplished by identifying a period of time during which an individual could have been diagnosed with a particular medical condition. In some implementations, this is accomplished by identifying a period of time during which an individual should have sought medical consultation for a medical condition. In some implementations, this is accomplished by identifying a period of time during which an individual did not have a prescription/instruction available to them for a recommended therapy (e.g., was not prescribed a pharmaceutical agent, dietary consideration, or lifestyle change).

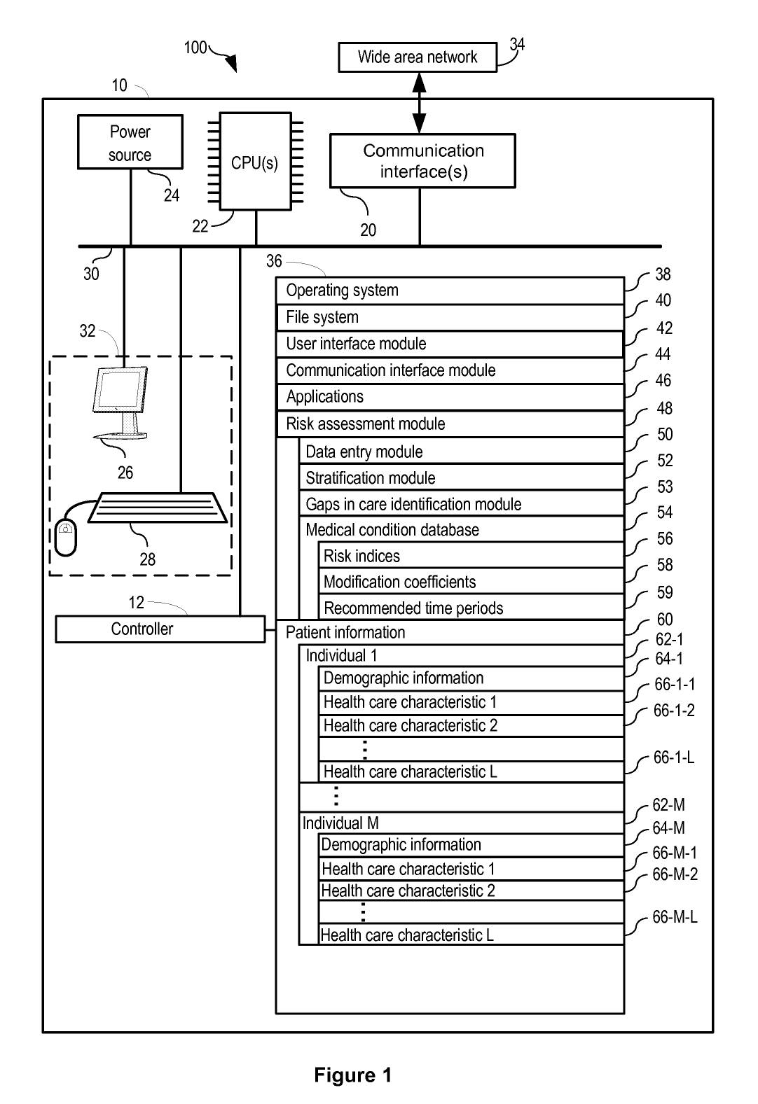

FIG. 1 is a block diagram of an electronic device 100 that represents any one or more of the processing server 212, database 214, processing device 234, or a combination of these devices. In some implementations, electronic device 100 includes: one or more processing units CPU(s) 22 (also called processors); memory 36, for example non-volatile memory (e.g., one or more magnetic disk storage devices, one or more flash memory devices, one or more optical storage devices, and/or other non-volatile solid-state memory devices), the memory 36 preferably controlled by storage controller 12; a user interface 32 including one or more input devices (e.g., a keyboard 28, mouse, touchpad, touch screen, or other input device) and a display 26 or other output device; a network interface card 20 (communications circuitry) for connecting to any wired or wireless communication network 34 (e.g., a wide area network such as the Internet); a power source 24 to power the aforementioned elements; and one or more communication buses 30 for interconnecting the aforementioned elements of the system.

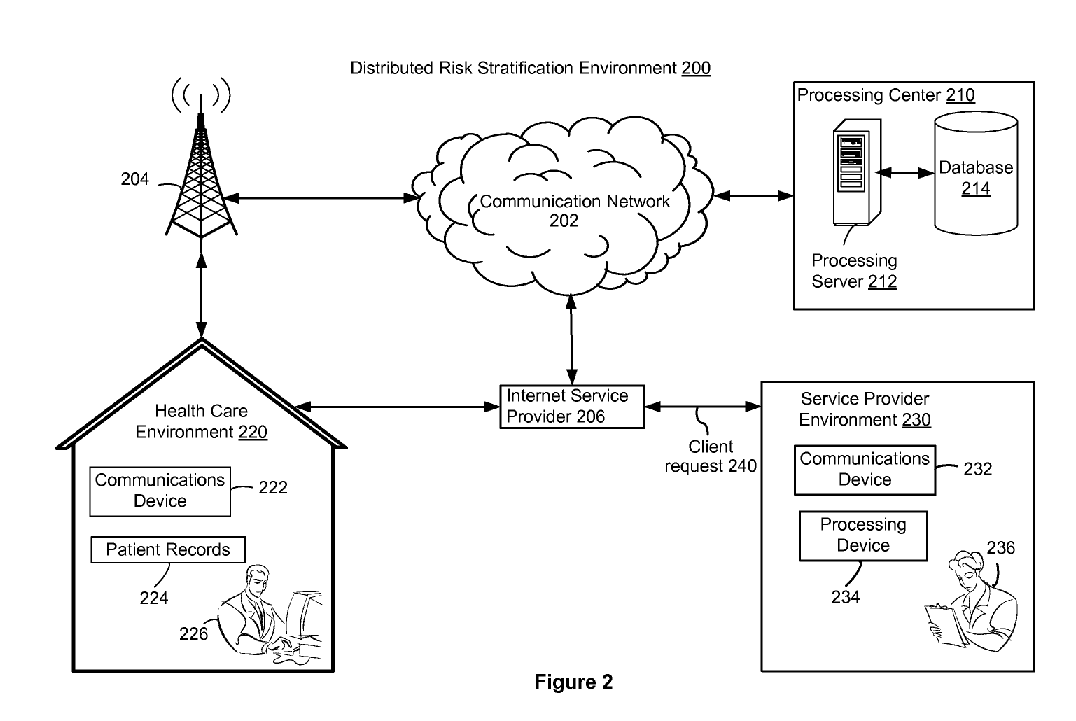

In some implementations, the memory 36 includes an operating system (control software) 38, which is executed by central processing unit 22. In some implementations, the memory 36 also includes: a file system 40 for controlling access to the various files and data structures used herein; a user interface module 42 for facilitating user interface processing; a communication interface module 44 for facilitating communications with one or more additional electronic devices, servers, or databases (e.g., processing server 212, database 214, communications device 222, and patient records 224, as illustrated in FIG. 2); applications 46 for facilitating functionalities of various additional user applications; a risk assessment module 48 for facilitating execution of the methods described herein for identifying gaps in a patient's medical care and/or stratifying individuals' risks of generating a high level of health care-related costs; and a patient information data store 60 for temporary or long-term storage of medical information.

In some implementations, using the modules (e.g., data entry module 50, stratification module 52, gaps in care identification module 53) medical condition database 54 (e.g., risk indices 56, modification coefficients 58, recommended time periods 59), and patient information 60 (e.g., individual 62, demographic information 64, and health care characteristics 66) implemented in the risk assessment module 48, the electronic device 100 performs at least some of the following: identifying a gap in medical care for an individual; identifying additional medical risk factors; associating indexed values with individual identified risk factors; determining indexed values associated with classes of medical risk metrics; determining health care indexed values for individuals; determining a risk of an individual generating a high level of health care-related costs; assigning individuals to one of a plurality of strata based on the individual's risk of generating a high level of health care-related costs; stratifying a set of individuals into a plurality of strata associated with different levels of risk of generating a high level of health care-related costs; assigning medical resources based on identified risks of generating a high level of heath care-related costs; monitoring an individual's health care and health care-related costs; re-evaluating an individual's risk of generating a high level of health care-related costs; and adjusting algorithms used to stratify individuals based on their risks of generating a high level of health care-related costs.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 36 optionally stores a subset of the modules and data structures identified above. Furthermore, the memory 36 may store additional modules and data structures not described above.

In some implementations, memory 36 may include additional instructions or fewer instructions. Furthermore, various functions of the electronic device 100 may be implemented in hardware and/or in firmware, including in one or more signal processing and/or application specific integrated circuits, and the electronic device 100, thus, need not include all modules and applications illustrated in FIG. 1.

In some implementations, the data entry module 50 facilitates entry of medical information (e.g., patient information 60, including individuals 62, demographic information 64, and health care characteristics 66). In some implementations, data entry module 50 facilitates uploading of medical records received in response to client request 240 for medical records for one or more individuals. In some implementations, data entry module 50 facilitates user interface with patient information 60, allowing a user to manually enter and/or update medical information for an individual 60.

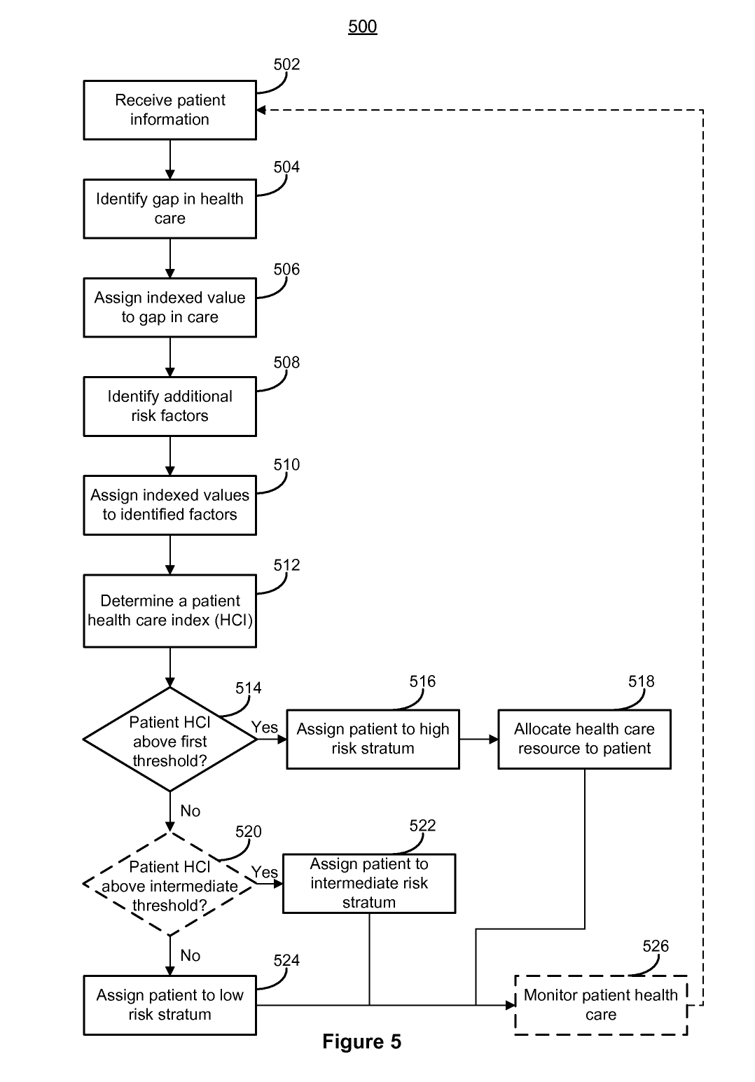

In some implementations, stratification module 52 facilitates the execution of methods, e.g., as described herein, for identifying an individual's risk for generating a high level of health care-related costs (e.g., method 500 in FIG. 5), stratifying a set of individuals into relative strata associated with varying risks of generating a high level of health care-related costs, and/or allocating health care resources based on an individual's, or group of individuals', relative risks of generating a high level of health care-related costs.

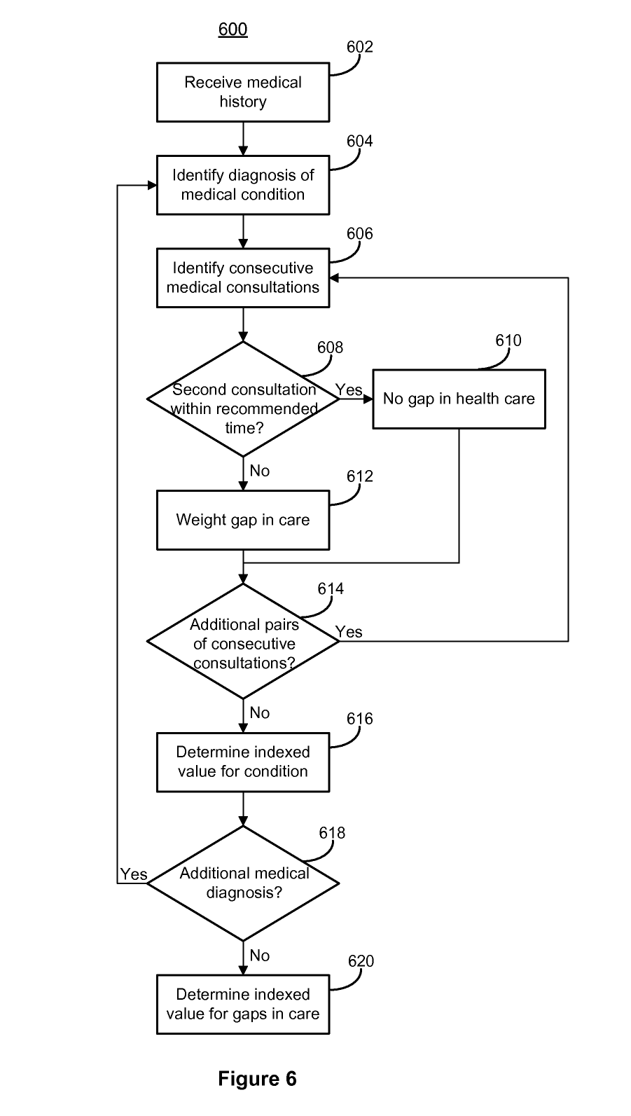

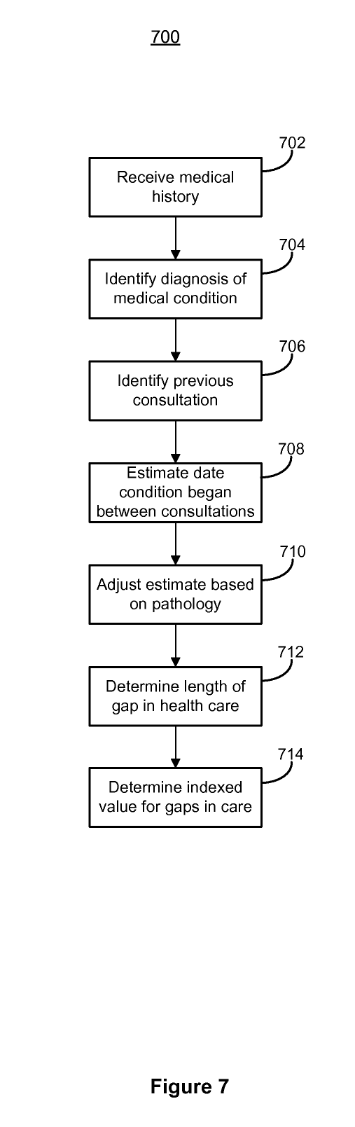

In some implementations, gaps in care identification module 53 facilitates the execution of methods, e.g., as described herein, for identifying a gap in an individual's medical care (e.g., methods 600 and 700 in FIGS. 6 and 7, respectively). In some implementations, the gaps in care identification module 53 identifies a gap in health care related to: a period of time beyond a recommended time for receiving a medical consultation; a period of time, prior to an individual being diagnosed with a particular medical condition, in which the individual did not receive advice and/or treatment for the medical condition; and/or a period of time, either before or after being diagnosed with a medical condition, in which the individual was prescribed a recommended therapy (e.g., a pharmaceutical agent, radiation therapy, dietary or lifestyle change, or other therapy).

In some implementations, medical condition database 54 includes one or more look-up tables containing information on risk indices 56 associated with particular types of health care metrics (e.g., gaps in care, diagnosed medical conditions, medication possession ratios, prescribed medications, histories of generating a high level of health care-related costs, histories of hospital visitations, and/or biometric characteristics), modification coefficients 58 associated with particular medical conditions, passage of time, and/or synergistic relationships (e.g., between two prescribed medications, between two diagnosed medication conditions, and/or between a prescribed medication and a diagnosed medical condition), and/or recommended time periods 59 for follow-up medical consultations. In some implementations, one or more parameters stored in medical condition database is adjustable, e.g., in response to updated medical recommendations, updated risk profiles for health care characteristics, and updated analyses of the relationship between health care characteristics and an individual's risk of generating a high level of health care-related costs.

In some implementations, patient information 60 includes medical information regarding one or more individuals 62 (e.g., individuals 62-1, . . . , and 62-M). In some implementations, the medical information includes demographic information 64 (e.g., demographic information 64-1, . . . and 64-M) for respective individuals 62 (e.g., information regarding the individual's name, address, age, ethnicity, etc.). In some implementations, the medical information includes health care characteristics 66 for respective individuals 60 (e.g., health care characteristics 66-1-1, 66-1-2, . . . 66-1-L, 66-M-1, 66-M-2, . . . 66-M-L). In some implementations, the health care characteristics 66 include partial or complete medical histories of respective individuals 62. In some implementations, the health care characteristics 66 include information related to health care metrics used by the methods described herein to classify an individual's risk of generating a high level of health care-related costs (e.g., information related to gaps in health care, diagnosed medical conditions, medication possession ratios, prescribed medications, histories of generating a high level of health care-related costs, histories of hospital visitations, and/or biometric characteristics).

In some implementations, stratification module 52 and/or gaps in care identification module 53 have access to medical condition database 54 and/or patient information 60, in order to execute the methods described herein. In some implementations, portions of, or all of, medical condition database 54 and/or patient information 60 is stored in memory located on a remote electronic device (e.g., database 214 in FIG. 2).

In some implementations, the methods described herein can be implemented on at least one data processing apparatus and/or a distributed network of computers. In some implementations, various virtual devices and/or services of third party service providers (e.g., third-party cloud service providers) may be employed to provide the underlying computing resources and/or infrastructure resources for the methods described herein.

FIG. 2 is a block diagram illustrating a distributed environment 200 for stratifying individual risks associated with the generation of high level of health care-related costs, in accordance with some implementations.

In some implementations, the distributed environment 200 includes one or more processing center(s) 210 each having one or more processing servers 212 and one or more databases 214. In some implementations, the distributed environment 200 also includes one or more service provider environments 230 having one or more communication devices 232 and processing devices 234 for local processing requests. In some implementations, the distributed environment 200 also includes one or more health care environments 220 having one or more communication devices 222 and one or more stored patient records 224.

In some implementations, a practitioner 236 (e.g., a data analyst, insurance agent, or medical professional), working at a processing device 234 in service provider environment 230, sends a client request 240, from a communications device 232 via communication network 202 (e.g., through internet service provider 206 and/or mobile server 204), requesting medical information on an individual or set of individuals from processing center 210 or one or more health care environments 220. In some implementations, after sending client request 240, processing device 234 receives requested medical information, via communications network 202. In some implementations, one or more methods described herein are performed at processing device 234, using the requested medical information, to identify a gap in an individual's medical care or to stratify a risk of an individual generating a high level of health care-related costs. In some implementations, processing device 234 accesses required information (e.g., medical condition database 54, risk indices 56, modification coefficients 58, and/or recommended time periods 59) stored in database 214 at processing center 210, via communication network 202, in order to perform a method described herein.

In some implementations, after sending client request 240, processing server 212 receives requested medical information, via communications network 202. In some implementations, one or more methods described herein are performed at processing server 212, optionally controlled by practitioner 236 (e.g., working at communications device 232 or processing device 234) via communications network 202. In some implementations, the results of the one or more performed methods are provided to practitioner 236 (e.g., via communications device 232 or processing device 234).

In some implementations, processing server 212 and/or database 214 includes risk assessment module 48, including one or more of data entry module 50, stratification module 52, medical condition database 54, risk indices 56, modification coefficients 58, and recommended time periods 59. In some implementations, risk assessment module is split between processing device 234, processing server 212, and database 214, with data entry module 50 stored at processing device 234. In some implementations, multiple processing devices 234 include copies of data entry module 50.

In some implementations, the communication network 102 optionally includes the Internet, one or more location connections, one or more local area networks (LANs), one or more wide area networks (WANs), other types of networks, or a combination of such networks. In some implementations, the one or more location connections optionally include connections by infrared signals, radio frequency signals, local area networks (LANs), Bluetooth, serial or parallel cable, or a combination of thereof. The communication network 102 may be implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

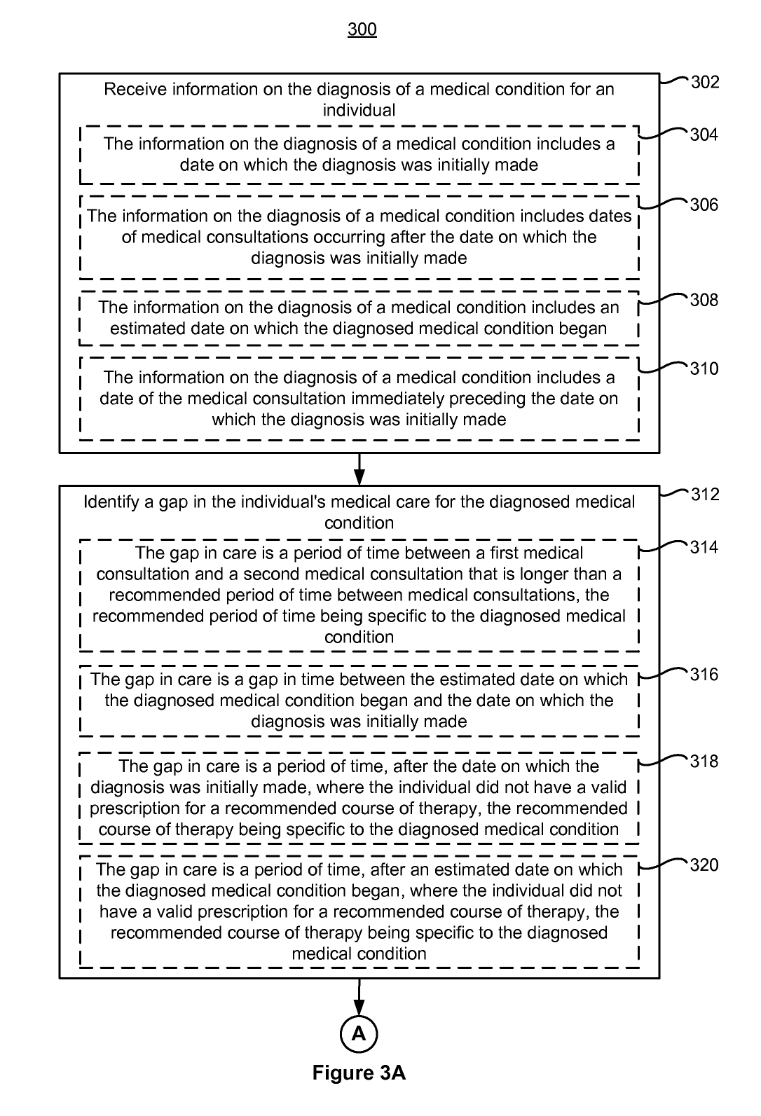

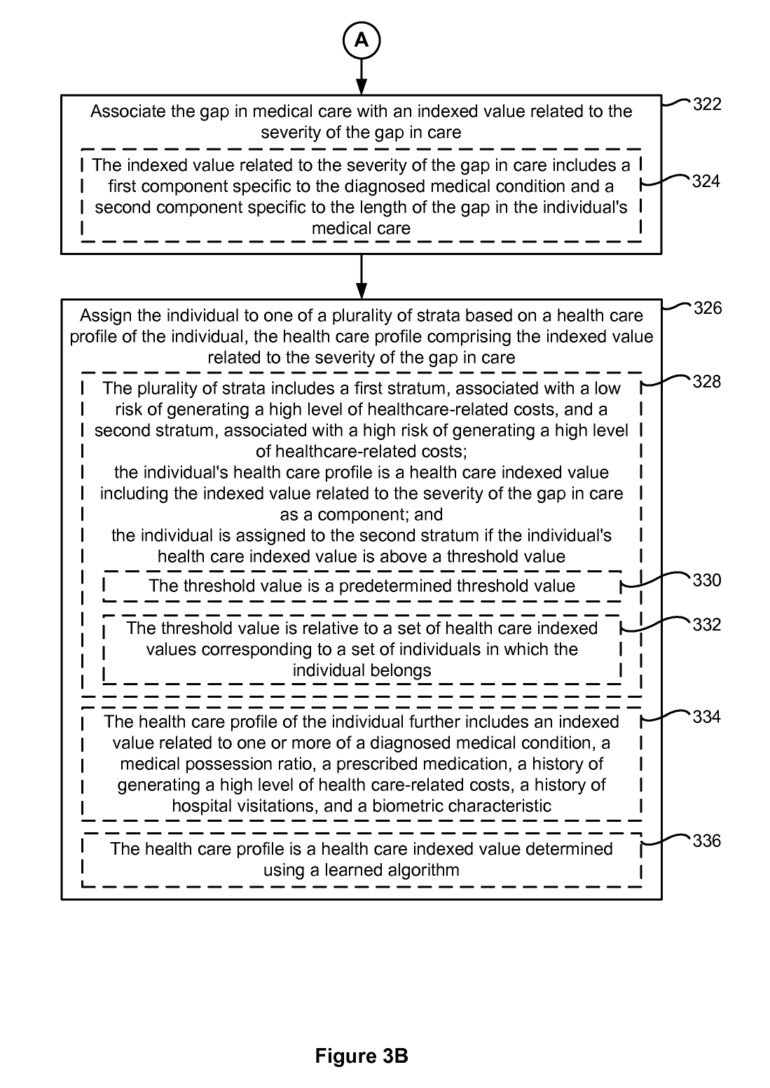

FIGS. 3A-3B are flow diagrams illustrating a method 300 of assigning an individual to a stratum associated with a risk of generating a high level of health care-related costs, in accordance with some implementations. The method 300 is performed at an electronic device (e.g., electronic device 100, FIG. 1) with a processor 22 and memory 36 storing instructions for execution by the processor. As described below, the method provides improved methods for scoring and stratifying an individual's health risk and potential for generating a high level of health care-related costs. Thereby allowing recognition of individuals who would most benefit from preemptive health care intervention. Accordingly, the overall risk of creating high levels of health care spending within a portfolio of insured individuals can be reduced by identifying those individuals at greatest risk for health complications.

In some implementations, an electronic device (e.g., electronic device 100) receives (302) information on the diagnosis of a medical condition for an individual (e.g., receipt of patient information 502 in FIG. 5). In some implementations, the information is a partial or complete medical history of the individual. Medical histories include electronic files received from medical providers (e.g., hospitals, doctor's offices, health care organizations, insurance companies, etc.), as well as physical medical files (e.g., paper charts) entered into the electronic device manually (e.g., typed or scanned and then OCR'ed). In some implementations, the information is a pre-existing medical record on a server or database maintained by the health care provider performing the methods described herein.

In some implementations, the information on the diagnosis of a medical condition includes a date on which the diagnosis was initially made (304). In some implementations, the information on the diagnosis of a medical condition includes dates of medical consultations occurring after the date on which the diagnosis was initially made (306). For example, in some implementations, the information is a partial or complete medical history for the individual (e.g., patient information 60 for an individual 62 in FIG. 1), including dates of medical consultations and diagnoses (e.g., health care characteristics 66 in FIG. 1) made by the consulting medical professional (e.g., doctor, therapist, or registered nurse).

In some implementations, the information on the diagnosis of a medical condition includes an estimated date on which the diagnosed medical condition began (308). In some implementations, dates on which a medical condition likely began can be estimated from information obtained from the medical professional who made the initial diagnosis. The severity/progression of a medical condition, upon initial diagnosis, provides clues as to how long it has been present in the patient. For example, an advanced, stage III cancer will have been present in the individual for a longer time, prior to initial diagnosis, than an early, stage I cancer of the same type. Based on these observations, the medical professional can estimate the length of time the medical condition was present in the individual prior to the consultation during which it was detected.

In some implementations, the information on the diagnosis of a medical condition includes a date of the medical consultation immediately preceding the date on which the diagnosis was initially made (310). In some implementations, the electronic device determines an estimated date on which the diagnosed medical condition began, based on the medical history of the individual and/or characteristic information of the underlying medical condition (e.g., information stored in medical condition database 54 in FIG. 1). In some implementations, where the underlying medical condition was not detected during a medical consultation immediately preceding the consultation at which the initial diagnosis was made, an estimated date between the two medical consultations is used as the estimated date on which the diagnosed medical condition began. In one implementation, the estimated date is the day halfway between the two medical consultations (e.g., if the medical condition was diagnosed on November 1, and not detected during a consultation on September 1, of the same year, the date on which the condition began is estimated as October 1, of that year).

In other implementations, where the diagnosed medical consultation was unlikely to have been detected during a preceding consultation, the medical professional or electronic device will ignore the date of the previous medical consultation, and instead rely on the pathology of the condition to estimate date on which the condition began. For example, where a woman is diagnosed with breast cancer during a medical consultation, if the previous medical consultation did not include a breast examination, it would be unlikely to have been detected. In some implementations, a previous medical consultation during which the condition would have been expected to have been detected (e.g., a preceding consultation during which a breast examination was performed), is used to bound and/or determine the estimated date on which the condition began.

The electronic device (e.g., electronic device 100) then identifies (312) a gap in the individual's medical care (e.g., identification of gap in health care 504 in FIG. 5) for the diagnosed medical condition. In some implementations, the gap in care is identified by determining a period of time between a first medical consultation and a second medical consultation that is longer than a recommended period of time between medical consultations, the recommended period of time being specific to the diagnosed medical condition (314).

In some implementations, the recommended period of time is a time determined by the medical professional. For example, a doctor may instruct a patient, after being diagnosed with a medical condition, to schedule a follow-up consultation within a certain period of time, e.g., three months. If the patient fails to return for a follow-up consultation within the prescribed time period (e.g., as queried at 608 in FIG. 6), the time between the last day given by the doctor and the date of the next consultation is considered a gap in care (e.g., as weighted at 612 in FIG. 6). Thus, if the patient, instructed to return within three months doesn't visit the doctor for five months, the two month period between the expiration of the three month window and the next consultation (at the five month mark), is a gap in health care.

In some implementations, the recommended period of time is a predetermined time specific to particular diagnosis. The recommended time may be determined, for example, by a medical organization (e.g., a hospital or other health care service provider, a general practice public health association such as the American Public Health Association (APHA), a specialized public health care association such as the American Heart Association(AHA)), an independent panel of health care professionals, an insurance agency, or a governmental health agency such as the Department of Health and Human Services (HHS). For example, where two consecutive medical consultations are identified in an individual's medical record (e.g., as identified at 606 in FIG. 6), the time elapsed between the consultations is compared to a recommended period of time between consultations for a medical condition diagnosed for the individual (e.g., as queried in 608 in FIG. 6). If the time period elapsed between consecutive consultations is longer than the recommended period of time, the excess time is considered a gap in care (e.g., as weighted at 612 in FIG. 6).

In some implementations, the gap in care is identified by determining a gap in time between the estimated date on which the diagnosed medical condition began and the date on which the diagnosis was initially made (316). For example, where a patient is initially diagnosed with a stage II cancer, a medical professional, computational algorithm, or combination thereof, determines an approximate date on which the cancer began, as described above (e.g., estimation 708 and optional adjustment 710 in FIG. 7). In such implementation, the time elapsed between the estimated date and the date of the diagnosis (e.g., as determined in 712 in FIG. 7) is considered a gap in care.

In some implementations, the gap in care is identified by determining a combination of periods of time in which the individual was not receiving recommended medical attention. These periods of time include those after the condition began, but before the condition was diagnosed, as well as those periods, after initial diagnosis of the condition, in which the individual waited longer than a recommended period of time between medical consultations (e.g., as gaps identified as in FIGS. 6 and 7). In some implementations, this measure of a gap in the individual's medical care is referred to as an aggregate gap in medical consultations. In some implementations, this measure is a simple aggregate of the time periods, before and after diagnosis, in which the individual was not receiving recommended medical attention. In some implementations, the gaps in medical consultations for more than one condition diagnosed for an individual (e.g., all diagnosed conditions) are aggregated together.

In some implementations of an aggregate gap in medical consultations, the individual gaps in care are weighted according to the length of the gap, the severity of the diagnosed medical condition during the gap, or a combination thereof (e.g., as weighted at 612 in FIG. 6). In this fashion, shorter gaps in care (e.g., where the patient waited only a few days longer than recommended between consultations) and gaps during which the condition was less severe (e.g., where the patient had pre-hypertension blood pressure as compared to stage 2 hypertension) are de-emphasized. In some implementations, short gaps in care are disregarded, such that periods of time below a predetermined threshold are not considered gaps in care. In some implementations, all gaps in care meeting certain criteria (e.g., above a length of a specified threshold) are weighted equally. In some implementations, all gaps in care are weighted proportional to the length in time only.

In some implementations, the gap in care is identified by determining a period of time, after the date on which the diagnosis was initially made, where the individual did not have a valid prescription for a recommended course of therapy, the recommended course of therapy being specific to the diagnosed medical condition (318). For example, after an initial diagnosis is made, any period of time before the medical professional prescribes a recommended course of therapy, such as when the medical professional is conducting additional tests to confirm a diagnosis or prescribes a non-recommended course of therapy, is considered a gap in care. Non-limiting examples of types of recommended courses of therapy included prescription of a pharmaceutical agent, a radiation treatment, a physical therapy, a dietary change, or another type of lifestyle change. As per recommended time periods between medical consultations, a recommended course of therapy by may be determined, for example, by a medical organization (e.g., a hospital or other health care service provider, a general practice public health association such as the American Public Health Association (APHA), a specialized public health care association such as the American Heart Association(AHA)), an independent panel of health care professionals, an insurance agency, or a governmental health agency such as the Department of Health and Human Services (HHS).

In some implementations, the gap in care is identified by determining a period of time, after an estimated date on which the diagnosed medical condition began, where the individual did not have a valid prescription for a recommended course of therapy, the recommended course of therapy being specific to the diagnosed medical condition (320). As described above, an estimated date on which a diagnosed medical condition began is determined by a medical professional, a computational algorithm, or a combination thereof. In such implementation, the period of time between the estimated date and the date on which the medical professional prescribed a recommended therapy is a gap in care.

The electronic device then associates (322) the gap in medical care with an indexed value related to the severity of the gap in care. In some implementations, the indexed value related to the severity of the gap in care includes a first component specific to the diagnosed medical condition and a second component specific to the length of the gap in the individual's medical care (324).

In some implementations, the indexed value related to the severity of the gap in care is a measure of an aggregate of multiple gaps in care for a single diagnosis (e.g., as determined at 616 in FIG. 6). In some implementations, the indexed value related to the severity of the gap in care is a measure of an aggregate of multiple gaps in care for a plurality of diagnosed conditions (e.g., as determined at 620 in FIG. 6).

In some implementations, the indexed value related to the severity of the gap in care is specific to gaps in medical consultations. In some implementations, the indexed value related to the severity of the gap in care is specific to a gap in a valid medical prescription. In some implementations, the indexed value related to the severity of the gap in care is an aggregate of gaps in medical consultations and gaps in valid medical prescription. In some implementations, an indexed value determined by aggregating gaps in care for multiple medical conditions is simply the sum of individual indexed values for each respective medical condition. In some implementations, where two or more medical conditions cause synergistic deleterious effects, the individual indexed values for the respective synergistic medical conditions are weighted using a multiplier, to reflect the greater than aggregate effect of having multiple medical conditions.

The electronic device then assigns (326) the individual to one of a plurality of strata based on a health care profile of the individual, the health care profile comprising the indexed value related to the severity of the gap in care. Each stratum represents a range of risks of generating a high level of health care-related costs. For example, a first stratum includes individuals having the greatest risk of generating a high level of health care-related costs, a second stratum includes individuals having the lowest risk of generating a high level of health care-related costs, and one or more optional intermediate strata include individuals having moderate risks of generating a high level of health care-related costs. The exact number and relative division of stratum in which a set of individuals is divided into will depend upon a number of factors, including without limitation: the purpose for stratifying individuals, the number of individuals in the set to be stratified, and the health care resources available or potentially available.

In some implementations, the plurality of strata includes a first stratum, associated with a low risk of generating a high level of healthcare-related costs, and a second stratum, associated with a high risk of generating a high level of healthcare-related costs; the individual's health care profile is a health care indexed value including the indexed value related to the severity of the gap in care as a component; and the individual is assigned to the second stratum if the individual's health care indexed value is above a threshold value (328).

In some implementations, the threshold value is a predetermined threshold value (330). For example, where an insurance agency is determining a cost of coverage for an individual (e.g., an estimated cost to the insurance agency or premium payment for the individual), the agency determines one or more threshold level dividing two or more strata in order to associate an individual with a particular risk of generating a high-level of health care-related costs. In this fashion, the number and relative distribution of the strata will depend upon the number of distinctions the insurance agency desires to make within an applicant pool, insured pool, or combination thereof (e.g., 1, 2, 3, 4, 5, 6, 7, 8, 9, 10, or more distinctions). In some implementations, the agency will determine a prediction of the individual's health care-related costs (e.g., a monthly, bi-annual, annual, policy-length, or other prediction of generated health care-related costs). In some implementations, the agency will simply determine an indexed value relative to a predicted risk of generating health care-related costs. In this fashion, the threshold value may represent either a predicted health care-related cost for the individual over a certain time period or an indexed value relative to a risk or predicted magnitude of future generation of health care-related costs.

In some implementations, the threshold value is relative (332) to a set of health care indexed values corresponding to a set of individuals in which the individual belongs (e.g., a set of insured individuals, a set of applicants for insurance, or a combination thereof). For example, in some implementations, where a health care insurance company has a set amount of additional resources (e.g., employed health care case officers), individuals are assigned to one of two strata: a first stratum, of a fixed capacity, representing patients who will receive an additional resource (e.g., will be assigned a health care case officer); and a second stratum, of unlimited capacity, representing patients who will not receive an additional resource. In some implementations, more than two strata are utilized to provide greater distinctions between the set of individuals being evaluated. For example, if different tiers of available health care resources are available to the company, individuals assigned to a first stratum receive a first type of available resource (or a first level of a health care resource, e.g., a certain number of hours of preemptive attention from a health care case officer). Individuals assigned to a second, intermediate stratum, receive a second type or available resource (or second, generally lower, level of a health care resource, e.g., a lesser number of hours of preemptive attention from a health care case officer).

In some implementations, the health care profile of the individual further includes an indexed value (or a predicted future health care-related cost accounts) for one or more of a diagnosed medical condition, a medication possession ratio, a prescribed medication, a history of generating a high level of health care-related costs, a history of hospital visitations, and a biometric characteristic (334). As described herein, all combinations of these factors are contemplated for use with a metric for gaps in medical care.

In some implementations, the health care profile is a health care indexed value determined using a learned algorithm (336). In some implementations, the algorithm used to determine a health care indexed value is modified as data on health care-related costs generated within a population of individuals (e.g., individuals stratified into groups relating to differing risks of generating a high level of health care-related costs using a first generation of the algorithm) is tracked and collected over time. In this fashion, the algorithm can be refined to more accurately classify individuals based on their risks of generating a high level of health care-related expenses.

In one implementation, this is achieved by adjusting indexed values and/or severity coefficients associated with various health care metrics described herein (e.g., gaps in care, diagnosed medical conditions, medication possession ratio, etc.), after observing that pre-defined values are not proportional to actual risks or generation of health care-related expenses. For example, by further characterizing relationships between the metrics and actual data on health care-related costs collected from a set of individuals being tracked. In some implementations, linear regression is used to establish and modify relationships between the metrics used for stratification and actual generation of health care-related costs.

In one implementation, a database of patient information, including diagnostic information and accumulated health care related expenses, collected over time for an open or closed set of individuals, is constructed. This database will contain information related to the health of the individuals, as well as the health care-related expenses generated by each of the individuals in the set. Pattern classification is used to mine the database for relationships between medical characteristics (e.g., gaps in patient care, diagnosed medical conditions, medication possession ratios, etc.) and generation of health care related expenses. In some implementations, pattern classification techniques (e.g., artificial intelligence) is used to refine the algorithm used to classify new individuals entering the set (e.g., individuals signing up for a health care plan) or to re-stratify an existing set of individuals. In this fashion, preemptive medical resources are redistributed over time, as a refined algorithm learns to better identify those individuals having the greatest need for such services.

Non-limiting examples of algorithms that may be used, in some implementations, for decision rule include: discriminant analysis including linear, logistic, and more flexible discrimination techniques (see, e.g., Gnanadesikan, 1977, Methods for Statistical Data Analysis of Multivariate Observations, New York: Wiley 1977; tree-based algorithms such as classification and regression trees (CART) and variants (see, e.g., Breiman, 1984, Classification and Regression Trees, Belmont, Calif.: Wadsworth International Group; generalized additive models (see, e.g., Tibshirani, 1990, Generalized Additive Models, London: Chapman and Hall; neural networks (see, e.g., Neal, 1996, Bayesian Learning for Neural Networks, New York: Springer-Verlag; and Insua, 1998, Feedforward neural networks for nonparametric regression In: Practical Nonparametric and Semiparametric Bayesian Statistics, pp. 181-194, New York: Springer, the entire contents of each of which are hereby incorporated by reference herein.

In some implementations, an electronic device (e.g., electronic device 100) receives (402) a plurality of medical histories, each medical history in the plurality of medical histories corresponding to an individual in a set of individuals, wherein respective medical histories in the plurality of medical histories include information on the diagnosis of a medical condition for the corresponding individual. In some implementations, the medical histories are collected over time and stored in a data store (e.g., as patient information 60 in FIG. 1). In some implementations, the medical histories of individuals are collected from a variety of sources, e.g., hospitals, doctor's offices, health care organizations, insurance companies, etc. In some implementations, the methods of stratifying individuals as described herein, are performed on pre-existing databases of patient medical records. In some implementations, the methods of stratifying individuals as described herein, are performed on databases or collections of patient medical records specifically collected for this purpose.

In some implementations, the information on the diagnosis of a medical condition includes a date on which the diagnosis was initially made (404). In some implementations, the information of the diagnosis of a medical condition includes dates of medical consultations occurring after the date on which the diagnosis was initially made (406). In some implementations, the information on the diagnosis of a medical condition includes an estimated date on which the diagnosed medical condition began (408). In some implementations, the information on the diagnosis of a medical condition includes a date of the medical consultation immediately preceding the date on which the diagnosis was initially made (410).

The electronic device then identifies (412) gaps in the medical care of respective individuals for their corresponding medical conditions (e.g., identification of gap in health care 504 in FIG. 5). In some implementations, respective gaps in care are periods of time between a first medical consultation and a second medical consultation that is longer than a recommended period of time between medical consultations, the recommended period of time being specific to the corresponding diagnosed medical condition (414). In some implementations, respective gaps in care are gaps in time between an estimated date on which a diagnosed medical condition began and the date on which the diagnosis was initially made (416).

In some implementations, respective gaps in care are periods of time, after a date on which a diagnosis was initially made, where the corresponding individual did not have a valid prescription for a recommended course of therapy, the recommended course of therapy being specific to the diagnosed medical condition (418). In some implementations, respective gaps in care are periods of time, after an estimated date on which a diagnosed medical condition began, where the corresponding individual did not have a valid prescription for a recommended course of therapy, the recommended course of therapy being specific to the diagnosed medical condition (420).

The electronic device then associates (422) each respective gap in medical care with an indexed value related to the severity of the respective gap in medical care. In some implementations, each indexed value related to the severity of a gap in care includes a first component specific to a diagnosed medical condition and a second component specific to a length of the gap in the corresponding individual's medical care (424).

In some implementations, an indexed value related to the severity of the gap in care for a respective individual in the set of individuals is specific to gaps in medical consultations. In some implementations, an indexed value related to the severity of the gap in care for a respective individual in the set of individuals is specific to a gap in a valid medical prescription. In some implementations, an indexed value related to the severity of the gap in care for a respective individual in the group of individuals is an aggregate of gaps in medical consultations and gaps in valid medical prescription. In some implementations, an indexed value determined by aggregating gaps in care for multiple medical conditions is simply the sum of individual indexed values for each respective medical condition. In some implementations, where two or more medical conditions cause synergistic deleterious effects, the individual indexed values for the respective synergistic medical conditions are weighted using a multiplier, to reflect the greater than aggregate effect of having multiple medical conditions.

The electronic device then assigns (426) respective individuals in the set of individuals to one of a plurality of strata based on corresponding health care profiles, each respective health care profile comprising an indexed value related to the severity of the respective gap in care. In this fashion, those individuals having the greatest risk of generating a high level of health care-related costs can be identified. In some implementations, these individuals are ear-marked to receive additional, optionally preemptive, resources to improve or maintain their health and reduce their risk of generating high levels of health care-related costs. In some implementations, these strata are used by an insurance agency (e.g., a health care or life insurer) to determine an individual's risk when deciding whether or not to insure the individual, and/or a premium at which to offer services.

In some implementations, the plurality of strata includes (428) a first stratum, associated with a low risk of generating a high level of healthcare-related costs, and a second stratum, associated with a high risk of generating a high level of healthcare-related costs; each respective individual's health care profile is a health care indexed value including the corresponding indexed value related to the severity of the corresponding gap in care as a component; and a respective individual is assigned to the second stratum if the individual's health care indexed value is above a threshold value. In some implementations, the threshold value is a predetermined threshold value (430).

In some implementations, the threshold value is relative to the set of health care indexed values corresponding to the set of individuals in which the respective individual belongs (432). In some implementations, e.g., where a limited amount of additional medical resources are available, setting the threshold value relative to the indexed values of the entire set allows a predetermined number of individuals to be classified into a particular strata. For example, where a service provider has the resources to provide health care case assistants for ten thousand individuals, the algorithm used to assign respective individuals to a corresponding strata is set such that exactly ten thousand individuals in the set of individuals are assigned to the top stratum (e.g., the stratum associated with the greatest risk of generating a high level of health care-related costs), regardless of what the actual risks are determined to be and regardless of the total number of individuals in the set of individuals.

In some implementations, the health care profile of each respective individual further includes (434) an indexed value related to one or more of a diagnosed medical condition, a medication possession ratio, a prescribed medication, a history of generating a high level of health care-related costs, a history of hospital visitations, and a biometric characteristic. As described herein, all combinations of these factors are contemplated for use with a metric for gaps in medical care.

In some implementations, each respective health care profile is a health care indexed value determined using a learned algorithm (436). In some implementations, the algorithm used to determine a health care indexed value is modified as data on health care-related costs generated within a population of individuals (e.g., individuals stratified into groups relating to differing risks of generating a high level of health care-related costs using a first generation of the algorithm) is tracked and collected over time. In this fashion, the algorithm can be refined to more accurately classify individuals based on their risks of generating a high level of health care-related expenses, as explained in greater detail above and below.

In some implementations, after assigning individuals to one of a plurality of strata (438): an electronic device tracks (440) health care related costs accrued for respective individuals in the set of individuals for a period of time (e.g., 6 months, a year, or in perpetuity). The electronic device then adjusts (442) a parameter used to determine the health care profiles of respective individuals in the set of individuals based on the health care costs accrued during the period of time. As described above, various algorithms for pattern classification and/or decision rule may be used to characterize relationships between individual parameters (e.g., health care characteristics 62 of the individual) and generation of health care-related costs or risk thereof

The electronic device then re-assigns (444) respective individuals in the set of individuals to one of a plurality of strata based on a health care profile of the respective individual, the health care profile including the adjusted parameter. In some implementations, an adjusted algorithm is used to re-assign all or a portion of individuals in the set of individuals (e.g., all patients of a health care insurance plan) into a plurality of strata based on adjusted risks of generating a high level of health care related costs. In this fashion, previous allocations of resources are re-evaluated based on either, or both, of new health care information about the individual (e.g., information collected after the initial assignment to a particular stratum) and new information about the relationship between types of health care characteristics (e.g., gaps in care, diagnosed medical conditions, medication possession ratios, prescribed medications, histories of health care costs, histories of hospital visitations, and biometric information) collected after the initial assessment.

In some implementations, after an initial assignment or re-assignment, of individuals to strata based on their risk of generating a high level of health care-related costs, medical resources are allocated (446) based on the assignment of individuals into a stratum associated with a high risk of generating a high level of healthcare-related costs. In this fashion, the health care of high risk individuals may be monitored more closely or preemptively treated in order to reduce the overall risk of, or ultimate accumulation of, health care-related expenses. In some implementations, the medical resources include a medical outreach program (448). For example, a health care provider may assign case officers (e.g., nurses or other medical professionals) to more closely track the health of high risk individuals to improve their health or identify potential health care problems at an earlier stage, ultimately improving the quality of health care for those individuals and reducing overall health care-related costs. In some implementations, the medical resources include providing feedback to respective individuals based on their corresponding healthcare profile or a component thereof (450).

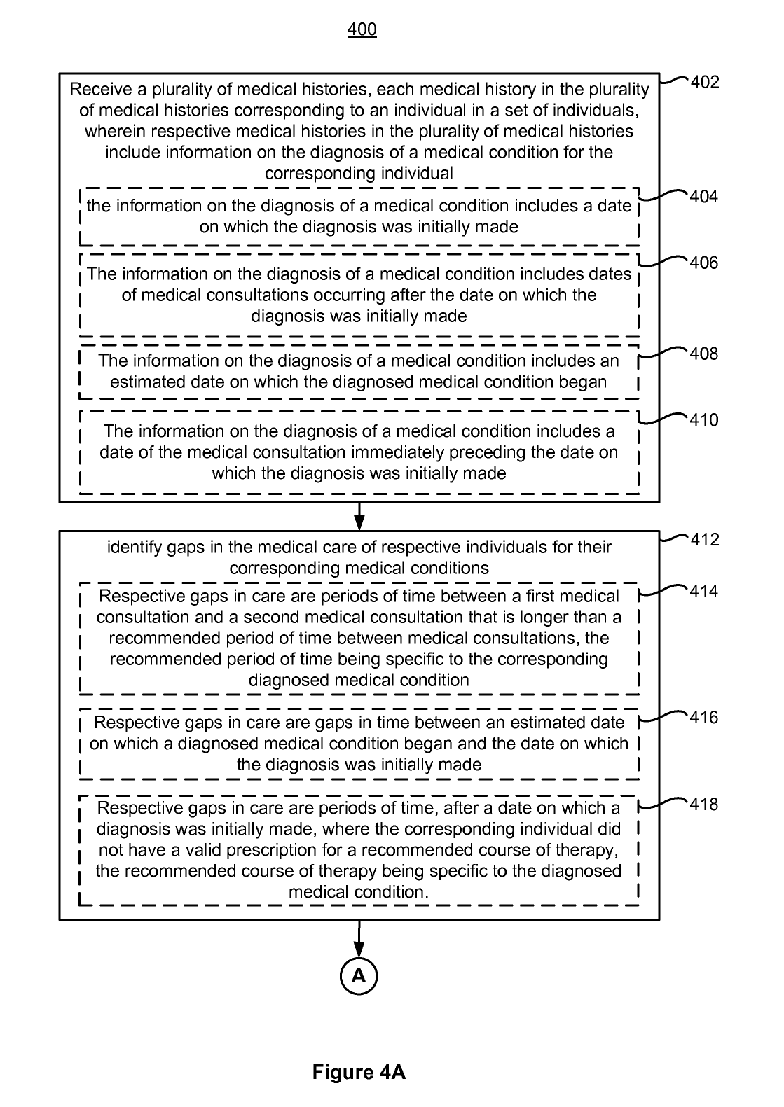

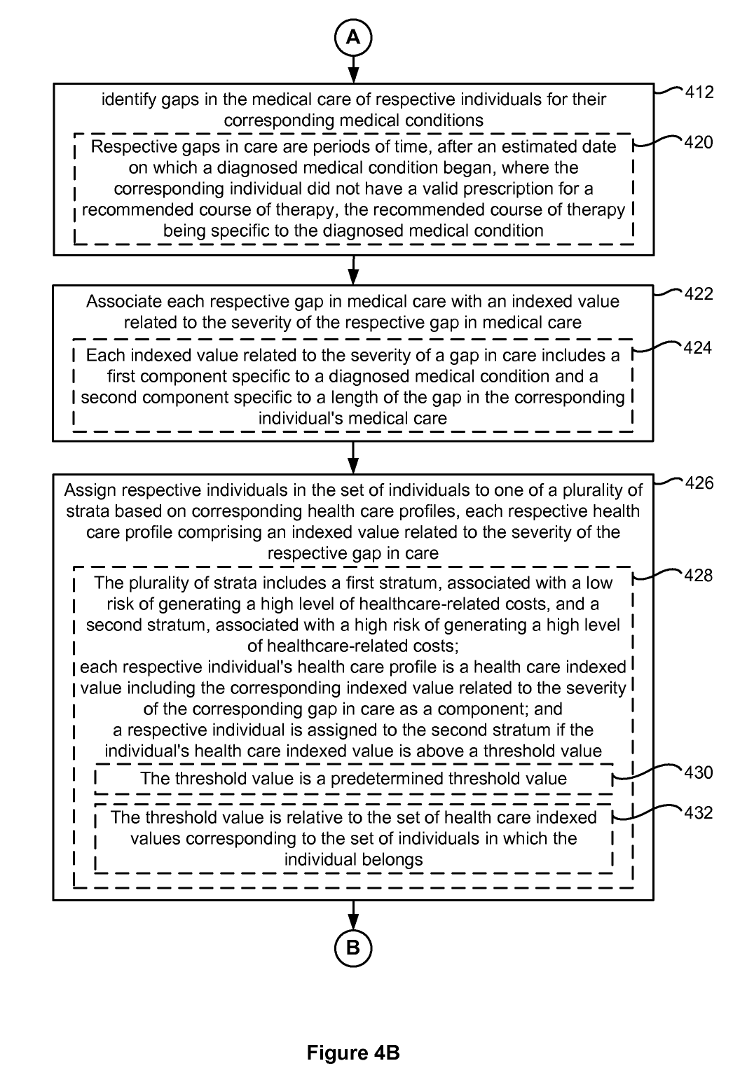

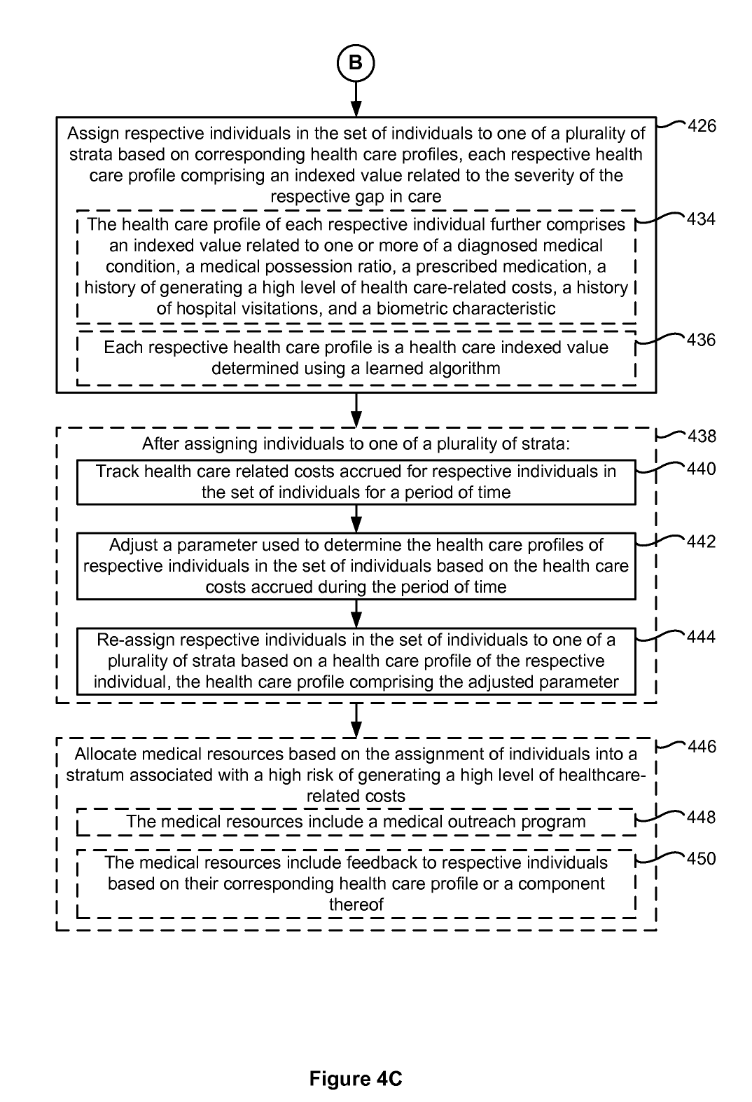

It should be understood that the particular order in which the operations in FIGS. 3A-3B and 4A-4C have been described is merely exemplary and is not intended to indicate that the described order is the only order in which the operations could be performed. One of ordinary skill in the art would recognize various ways to reorder the operations described herein.

Exemplary Methods

Now that an overview of the methods and systems for stratifying risks in a population of patients by identifying metrics associated with high levels of health care costs, such as gaps in medical care exemplary methods will be presented in conjunction with FIGS. 5-7.

FIG. 5 illustrates exemplary method 500 for assigning an individual to a strata associated with a relative risk of generating a high level of health care-related costs. In step 502, an electronic device (e.g., electronic device 100) receives patient information (e.g., a partial or complete medical history for the individual). In some implementations, the patient information is received from a hospital, doctor's office, medical service provider, insurance carrier, or other external health care service provider (e.g., health care environment 220 in FIG. 2). In some implementations, the patient information is accessed from an internal company database (e.g., database 214 in FIG. 2 or patient data store 60 in FIG. 1). In some implementations, the patient information is manually inputted (e.g., by employee or practitioner 236 working in service provider environment 230 in FIG. 2) based on a physical medical record or graphical rendering of a physical medical record (e.g., the information present in the physical medical record is typed-in or scanned and OCR'ed).

In step 504, the electronic device identifies a gap in the patient's health care (e.g., a gap in medical consultation for a particular diagnosed or undiagnosed medical condition and/or gap in a recommended therapy). Exemplary methods 600 and 700 for identifying gaps in medical care are illustrated in FIGS. 6 and 7, respectively.

In step 506, the electronic device assigns an indexed value to the identified gap in medical care. In some implementations, an indexed value for a particular gap is care is looked-up in a database (e.g., medical condition database 54 in FIG. 1) containing pre-assigned indexed values for particular gaps in medical care (e.g., risk indices 56 in FIG. 1). In some implementations, the indexed value is adjusted based on a particular diagnosis made for the patient, for example, using a coefficient specific to the diagnosed medical condition (e.g., a respective modification coefficient in the modification coefficients 58 in FIG. 1). In some implementations, the risk index assigned (e.g., a respective risk index in risk indices 56 in FIG. 1) to the identified gap in medical is specific to the diagnosed medical condition. In some implementations, the assigned risk index is independent of any medical conditions diagnosed for the individual.

In step 508, the electronic device identifies any additional risk factors (e.g., a health care characteristic 66 satisfying an additional metric). In some implementations, the additional risk factor is a diagnosed medical condition, a medication possession ratio, a prescribed medication, a history of generating a high level of health care-related costs, a history of hospital visitations, and/or a biometric characteristic.

In step 510, the electronic device assigns an indexed value to the one or more identified additional risk factors. In some implementations, an indexed value for a particular risk factor is looked-up in a database (e.g., medical condition database 54 in FIG. 1) containing pre-assigned indexed values for particular risk factors (e.g., risk indices 56 in FIG. 1). In some implementations, the indexed value is adjusted based on a particular parameter of the risk factor (e.g., a parameter described in the following section), for example, using a coefficient specific to a severity of a diagnosed medical condition or passage of time (e.g., a respective modification coefficient in the modification coefficients 58 in FIG. 1). In some implementations, the risk index assigned (e.g., a respective risk index in risk indices 56 in FIG. 1) to an additionally identified risk factor is specific to the particular parameter. In some implementations, the assigned risk index is independent of any particular parameter.

In step 512, the electronic device determines a patient health care index (e.g., an indexed value indicative of a relative risk of the individual generating of a high level health care-related costs), based upon indexed values assigned to identified gaps in patient medical care (e.g., in step 506) and additional risk factors (e.g., in step 510). In some implementations, the patient health care index is an aggregated sum of individual indexed values. In some implementations, individual indexed values may be further weighted based upon identified combinations of risk factors which, when present together, provide more or less than an additive risk of creating a high level of health care-related costs. For example, where indexed values are assigned to a particular medical condition diagnosed for the patient and a particular medication prescribed to the patient, and the medication is known to cause a complication is individuals diagnosed with the particular medical condition, either or both of the indexed values may be adjusted to account for the additional risk. In some implementations, an increased risk due to a particular combination of risk factors may be accounted for by the addition of an indexed value specific to the identified combination of risk factors, without adjusting the indexed values for the individual risk factors.

In step 514, the electronic device compares the patient health care index (e.g., determined in step 512) to a first threshold level (e.g., a threshold associated with a particular risk of the individual generating a high level of health care-related costs). If the patient health care index is above the first threshold, the electronic device assigns the individual, in step 516, to a first stratum associated with a high risk of generating a high level of health care-related costs.

If the patient health care index is not above the first threshold, the electronic device, optionally, compares the patient health care index to one or more intermediate thresholds in step 520. If the patient health care index is above an intermediate threshold, the electronic device assigns the individual, in step 522, to an intermediary stratum associated with an intermediate risk of generating a high level of health care-related costs.

If the patient health care index is not above the first threshold or any of the optional intermediary thresholds, the electronic device assigns the individual, in step 524, to a low risk stratum associated with an intermediary risk of generating a high level of health care-related costs.

In some implementations, rather than comparing the patient's health care index to one or more thresholds, to assign the individual to an appropriate risk stratum, the patient's health care index is compared to the health care indices of other individuals of a group to which the patient belongs. In this fashion, the individuals in a particular group may be ranked, based upon their health care indices, to identify individuals at greatest risk for generating a high level of health care-related costs, regardless of the particular associated risk.

Optionally, the patient's health care and health care-related costs are monitored in step 526 for a period of time after assignment to a risk stratum (e.g., for six-months, a year, or in perpetuity). In some implementations, monitoring involves receiving medical information (e.g., from a doctor, hospital, health care organization, or insurer).

In some implementations, newly acquired information regarding the individual's ongoing health care can be added to the information used to initially classify the individual into one of a plurality of strata (e.g., feedback loop connecting step 526 back to step 502). In some implementations, the new information is used to re-classify (e.g., adjust the classification) the individual into a particular stratum, where the individual's relative risk of generating a high level of health care-related costs changes based on the newly acquired information. In some implementations, where the newly acquired information is used to re-classify the individual, weighting of the old medical information on the patient is modified, for example, by discounting and/or ignoring indexed values for old health care characteristics that are less relevant in view of the new information or which fall outside of a time period used for evaluation of the particular metric.

In some implementations, classification of the individual is re-evaluated after new health care information about the individual is received (e.g., immediately or shortly after data entry or receipt). In some implementations, classification of the individual is re-evaluated from time to time, regardless of whether new health care information has been received. For example, in some implementations, all individuals (e.g., the set of individuals) or a sub-set thereof (e.g., individuals assigned to an intermediate risk stratum) are re-evaluated periodically (e.g., monthly, bi-annually, annually) or sporadically (e.g., upon a change in health care provider costs, or as determined by an individual or organization) to identify changes in individuals' relative risks of generating high levels of health care-related costs in the future.

FIG. 6 illustrates exemplary method 600 for determining an indexed value associated with gaps in an individual's medical care. In step 602, an electronic device (e.g., electronic device 100) receives patient information (e.g., a partial or complete medical history for the individual). In some implementations, as described above, the patient information is received from a health care provided, is accessed from an internal database, or is manually inputted.

In step 604, the device identifies the diagnosis of a medical condition within the medical history of the patient. The diagnosis may be an initial diagnosis or an indication of a previous diagnosis. For example, in some implementations, where only a partial medical history is used in the determination, clues that a medical professional is monitoring or treating a previously diagnosed medical condition are treated as if a diagnosis of the medical condition is present in the record.

In step 606, the electronic device identifies dates on which consecutive medical consultation were attended (e.g., starting with the consultation at which the medical diagnosis was first diagnosed or implicated as previously identified) by the individual and determines the period of time elapsed between the consultations.

In step 608, the electronic device queries whether the time elapsed between medical consultations (e.g., determined in step 606) is within a recommended time period. In some implementations, the recommended period of time is a period of time predetermined by a health care professional (e.g., a doctor, nurse, or health care consultant) or organization (e.g., a hospital, public, private, or governmental medical organization, or insurance company) in which a continuation or follow-up medical consultation should be performed to best treat or manage a particular medical condition. In some implementations, the electronic device looks-up a recommended period of time in a database of recommended time periods (e.g., recommended time periods 59 in FIG. 1). In some implementations, the recommended time period is a length of time defined by the treating health care professional or medical organization (e.g., a doctor treating a patient for a particular medical condition advises the patient to schedule a follow-up consultation within a specified period of time). In some implementations, the electronic device identifies a recommended period of time for a follow-up consultation from the patient's medical record. In some implementations, the electronic device prompts a user or other health care professional to determine a recommended period of time for a particular follow-up medical consultation. In some implementations, the user or health care professional is asked whether to use a predetermined recommended time or a period of time indicated by a treating health care professional identified in the individual's medical record.

If the time period between the consecutive consultations (e.g., identified in step 606) is determined to have occurred within a recommended period of time, the electronic device determines, in step 610, that a gap in the individual's medical care has not exist for the consecutive appointments and particular medical condition.

However, if the time period between the consecutive consultations is determined to not have occurred within a recommended period of time, the electronic device weights the identified gap in care (e.g., by assigning an indexed value associated with the severity of the gap in care) in step 612. In some implementations, the identified gap in care is not assigned an individual indexed value. For example, in some implementations, the identified gap is care is aggregated with other individual gaps in care identified for the particular diagnosed condition or for all diagnosed conditions identified for the patient.

In step 614, the electronic device determines whether additional pairs of consecutive consultations exist in the patient's medical history. If determined that additional consultations do exist, the electronic device returns to step 606 to determine if the newly identified set of consecutive consultations form a gap in the patient's medical care. If no further sets of consecutive consultations are identified, the electronic device determines an indexed value, in step 616, for gaps in the patient's medical care for the diagnosed medical condition (e.g., as identified in step 604). In some implementations, the indexed value for gaps in the patient's medical care for the diagnosed medical condition is an aggregate value of individual indexed values for individual gaps in care. In some implementations, the indexed value for gaps in the patient's medical care for the diagnosed medical condition is dependent upon an aggregated period of time for each identified gap in care.

In step 618, the electronic device determines whether an additional medical diagnosis has been made for the patient. If determined that an additional diagnosis exists, the electronic device returns to step 604 to determine if gaps in the patient's medical care exist for the newly identified medical diagnosis. If no further diagnoses are identified, the electronic device determines a final indexed value, in step 620, associated with all of the gaps in the patient's medical care.

In some implementations, the final indexed value associated with all of the gaps in the patient's care is an aggregate value of individual indexed values for individual gaps in care or specific diagnoses. In some implementations, the final indexed value associated with all of the gaps in the patient's care is dependent upon an aggregated period of time for each identified gap in care.

FIG. 7 illustrates exemplary method 700 for estimating a date on which a diagnosed medical condition began. In step 702, an electronic device (e.g., electronic device 100) receives patient information (e.g., a partial or complete medical history for the individual). In some implementations, as described above, the patient information is received from a health care provided, is accessed from an internal database, or is manually inputted.

In step 704, the device identifies the diagnosis of a medical condition within the medical history of the patient, including a date on which the diagnosis was made. In step 706, the device identifies the medical consultation immediately preceding the consultation during which the diagnosis was made.

In some implementations, it is assumed that the diagnosed medical condition was not present during the preceding consultation. Thus, in step 708, the electronic device estimates a date, between the date of the consultation in which the diagnosis was made and the date of the immediately preceding consultation, on which the medical condition began. In some implementations, the estimated date is half way between the date of the consultation during which the diagnosis was made and the date of the immediately preceding consultation.

In some implementations, e.g., where the pathology of the medical condition suggests that the medical condition began before or after a default estimate made by the electronic device, the estimated date on which the condition began is adjusted in step 710. In some implementations, the date is adjusted based on information collected by the diagnosing, or a subsequent, medical profession, optionally reported in the medical history. For example, a date on which the patient reported first experiencing a symptom consistent with the diagnosis (e.g., a patient diagnosed with strep throat may tell their doctor that their throat became sore about 7 days ago). In some implementations, the date is adjusted based on an observed or implied progression rate of the medical condition (e.g., a cancerous tumor is observed or known to grow at a certain rate or a viral infection is known to have an average latency period prior to presentation of symptoms).

In some implementations, where the immediately preceding medical consultation is of a type that would not be expected to lead to a particular diagnosis, a prior medical consultation may be used for the estimate. In some implementations, a medical professional auditing an estimate may change an estimated date based on their discretion and experience with the particular diagnosis. Thus, in some implementations, an estimated date on which a medical condition began is manually entered by a practitioner. In some implementations, the estimated date is determined by the electronic device.

In step 712, the device determines a length of the gap in care as the period of time between the estimated date the medical condition began and the date on which the diagnosis was made. In step 714, the device assigns an indexed value to the gap in care (e.g., as determined in step 712). In some implementations, the gap in care identified is aggregated with one or more gaps in care occurring after the initial diagnosis of the medical condition (e.g., as described above and illustrated in FIG. 6).

Health Care Profile Metrics

In one implementation, the health care profile of the individual includes an indexed value (or a predicted future health care-related cost accounting) for a medical condition the individual has been diagnosed as having. The indexed value (or value ascribed to a future generation of costs) is proportional to the risk of generating health care-related costs associated with the particular medical condition. For example, a medical condition without a cure, requiring expensive therapy in perpetuity (e.g., a primary immunodeficiency (PID) requiring costly intravenous immunoglobulin (IVIG) therapy in perpetuity for patient management), is assigned a higher indexed value (or higher value ascribed to future cost generation) than a condition readily cured by an inexpensive treatment (e.g., bacterial conjunctivitis, readily treatable with antibiotic eye drops).

In some implementations, an indexed value for diagnosed medical conditions is an aggregate of individual condition risk factors, each specific to a medical condition diagnosed for the individual. In some implementations, the aggregate is a simple sum of the individual risk factors, assigned independently for each diagnosed condition. In some implementations, the aggregate accounts for specific combinations of medical conditions, which when present together in an individual create a greater than additive risk of generating a high level of health care-related costs. In some implementations, the medical conditions may be weighted based on the age of the diagnosis and current status of the condition. For example, an older diagnosis of hypertension, which has subsequently been controlled by a change in lifestyle or prescription medication, is weighted less than a diagnosis of cancer currently under treatment.

In some implementations, an indexed value (or costs ascribed to a future generation of costs) associated with a medical condition is proportional to a severity or stage of the condition. For example, a stage I cancer, which is localized and potentially eliminated by resection surgery poses a lesser risk of generating future health care-related costs than does a metastasized stage IV cancer, requiring costly chemotherapy, radiation therapy, and/or multiple surgical resections. In some implementations, the severity or stage of a medical condition is accounted for by assigning a coefficient by which a value assigned to the underlying medical condition is multiplied. For example, the stage I cancer is assigned a severity coefficient of 1.0, while a stage IV cancer is assigned a severity coefficient of 5.0. The exact value of a severity coefficient is determined by a practitioner or computational algorithm. In some implementations, differing severities and/or stages of a disease are simply assigned different predetermined indexed values.

In some implementations, indexed values and/or severity coefficients are subject to adjustment, for example, after observing that an assigned value is not proportioned appropriately to actual generations of health-care related costs. Adjustment may be performed at the discretion of a practitioner or by computational algorithm. In one implementation, the generation of health care-related costs in a set of individuals is tracked over time and the relationship between individual medical conditions (and/or their severity) and actual health care-related costs generated is determined. If the determined relationship indicates that an indexed value (and/or severity coefficient) initially associated with a particular medical condition differs significantly from the actual generation of health care-related costs, it is adjusted to more closely resemble the actual relationship. In some implementations, the adjusted indexed value (and/or severity coefficient) is then used to re-evaluate individuals and adjust their stratification, if needed. In some implementations, the adjusted indexed value (and/or severity coefficient) is then used to assign individuals newly entering the set of individuals to an appropriate stratum in the plurality of strata.

In one implementation, the health care profile of the individual includes an indexed value (or a predicted future health care-related cost accounting) for a medication possession ratio. A medication possession ratio refers to the percentage of a time in which a patient, who has been prescribed a medication, has filled that prescription (e.g., at a pharmacy). In some implementations, a medication possession ratio is determined as the number of days a pharmaceutical agent was available to the individual over the intended period of the prescription (e.g., for prescription of 50-days worth of medication with two, full refills, the intended period is 150 days).

In some implementations, a medication possession ratio is determined as the number of days a pharmaceutical agent was available to the individual over the period of time extending through the end of the supply provided by the last refill (e.g., through 50 days after the second, and final, refill of the prescription described above). For example, an individual is prescribed a pharmaceutical for treatment of hypertension (e.g., a beta blocker) that includes an initial fill of 60-days worth of medication, with three, full refills, has a prescription valid for 240 days worth of medication. If the patient fills the prescription the same day it is written, and then refills the prescription at 71, 155, and 216 days thereafter, the individual will have the medication available (assuming they are taking the medication daily) for administration on 240 of 275 days over the course of the prescription, with gaps of 10 days (between the end of the initial fill and first refill), 25 days (between the end of the first refill and the second refill), and 0 days (between the end of the second refill and the third refill). Thus, their medication possession ratio for that drug is 240 days (available supply)/275 days (course of the prescription)=0.87.

In some implementations, an individual's medication possession ratio is calculated as an aggregate of the medication possession ratios of all prescribed pharmaceutical agents. In some implementations, certain medications or classes of medications are excluded from the determination. For example, pharmaceuticals used for pain management (e.g., analgesics such as non-steroidal anti-inflammatory drugs (NSAIDs), COX-2 inhibitors, opiates, and morphinomimetics) are excluded as non-essential to treatment of the underlying medical condition. In some implementations, the contribution of certain prescriptions to an overall medication possession ratio for the individual are weighted differently than others. For example, prescriptions may be weighted based on the age of the prescription (e.g., more recent patient behavior is weighted more strongly), the importance of the prescription (e.g., those prescriptions used to treat more severe medical conditions, or medical conditions associated with a greater risk of generating a high level of health care-related costs are weighted more strongly), or the risk of additional complications associated with sporadic compliance (e.g., those prescriptions used to establish and maintain a steady-state pharmacokinetic parameter or physiological state, such as blood pressure medication). In some implementations, this is achieved by adjusting each pharmaceutical-specific medication possession ratio with one or more coefficients associated with the age of the prescription and/or identity of the drug.

In one implementation, as described for indexed values related to diagnosed medical conditions, indexed values, and/or modifying coefficients thereof, related to medication possession ratios are re-evaluated and amended upon analysis of data suggesting initially assigned values vary substantially from observed relationships between a medication possession ratio and generated health care-related costs.

In one implementation, the health care profile of the individual includes an indexed value (or a predicted future health care-related cost accounting) for a medication the individual is currently, and/or was previously, prescribed. In some implementations, indexed values (or predicted future health care-related costs) are assigned for high risk drugs (e.g., pharmaceutical agents associated with adverse reactions or established risks thereof). In some implementations, the indexed values are dependent upon the severity and/or probability of the adverse reaction. In some implementations, the indexed values are alternatively, or additionally, weighted by the age of the prescription and/or patient history on the medication (e.g., medications that the patient has been taking for long periods of time without incident of an adverse reaction are weighted less than new prescriptions for which the individual's reaction to are unknown). In some implementations, the indexed values are dependent upon the cost of the prescription (e.g., more expensive prescriptions are weighted more heavily).

In some implementations, an indexed value for prescribed drugs is an aggregate of individual risk factors, each specific to a medication prescribed to the individual. In some implementations, the aggregate is a simple sum of the individual risk factors, assigned independently for each prescribed medication. In some implementations, the aggregate accounts for specific combinations of prescribed medication, which when prescribed together create a greater than additive risk of adverse reactions (e.g., pose a risk for deleterious drug interactions) or are associated with a greater than additive risk of generating a high level of health care-related costs.

In one implementation, as described for indexed values related to diagnosed medical conditions, indexed values, and/or modifying coefficients thereof, related to prescribed drugs are re-evaluated and amended upon analysis of data suggesting initially assigned values vary substantially from observed relationships between the prescription and generated health care-related costs.

In one implementation, the health care profile of the individual includes an indexed value (or a predicted future health care-related cost accounting) for a history of generating a high level of health care-related costs. In some implementations, an individual's recent insurance claim history is associated with one of a plurality of indexed values. For example, a prior year's claim history below of first threshold (e.g., $25,000) is associated with a first, low index value (alternatively associated with an indexed value of zero). A prior year's claim history above a first threshold but below a second threshold (e.g., $25,000<X<$100,000) is associated with a second, intermediate index value. A prior year's claim history above the second, or other intermediate threshold (e.g., $100,000) is associated with a third, high index value. In certain implementations, more than two threshold values are used to associate an appropriate indexed value for this parameter, e.g., at least 3, 4, 5, 6, 7, 8, 9, 10, or more threshold values. In some implementations, the indexed value is determined proportionally to the exact value of the previous year's claim history. In some implementations, only a single time frame (e.g., the previous 6-months or year) of claims is used to determine an indexed value for this parameter. In some implementations, a plurality of time frames (e.g., blocks of 3, 6, 9, 12, or more months) of claims are used to determine an indexed value, for example, in an aggregate fashion. In some implementations, where an aggregate indexed value for a cost history is determined, representative values for each period of time may be weighted based on their age (e.g., more recent cost histories are weighted more heavily than older periods of cost histories).

In one implementation, as described for indexed values related to diagnosed medical conditions, indexed values, and/or modifying coefficients thereof, related to a history of generating a high level of health care-related costs are re-evaluated and amended upon analysis of data suggesting initially assigned values vary substantially from observed relationships between the patient's history and generated health care-related costs.

In one implementation, the health care profile of the individual includes an indexed value (or a predicted future health care-related cost accounting) for a history of hospital visitations. In some implementations, the indexed value includes components for hospital admissions, hospital readmissions, and emergency room visitations made by the individual in a previous period of time (e.g., in the past 6, 12, or 24-months).

In some implementations, only hospital visitations made within a single period of time are used to determine an indexed value for this parameter. In some implementations, a plurality of time frames (e.g., blocks of 3, 6, 9, 12, or more months) of hospital visitations are used to determine an indexed value, for example, in an aggregate fashion. In some implementations, where an aggregate indexed value is determined, representative values for each period of time may be weighted based on their age (e.g., more recent hospital visitations are weighted more heavily than older hospital visitations).

In one implementation, as described for indexed values related to diagnosed medical conditions, indexed values, and/or modifying coefficients thereof, related to a history of hospital visitations are re-evaluated and amended upon analysis of data suggesting initially assigned values vary substantially from observed relationships between the patient's history of hospital visitations and generated health care-related costs.

In one implementation, the health care profile of the individual includes an indexed value (or a predicted future health care-related cost accounting) for a biometric (e.g., physiologic) characteristic of the individual. For example, an indexed value may be assigned to one or more physiologic characteristics including, without limitation, a resting heart rate, a blood pressure, a weight to height relationship, a body-mass index (BMI), a cholesterol level, a blood sugar level, a cognition score, a blood metabolite level.

In some implementations, an indexed value for biometric characteristics of the individual is an aggregate of individual risk factors, each specific to a biometric characteristic of the individual. In some implementations, the aggregate is a simple sum of the individual risk factors, assigned independently for each biometric characteristic. In some implementations, the aggregate accounts for specific combinations of biometric characteristics, which when present together create a greater than additive risk of generating a high level of health care-related costs.

In one implementation, as described for indexed values related to diagnosed medical conditions, indexed values, and/or modifying coefficients thereof, related to biometric characteristics are re-evaluated and amended upon analysis of data suggesting initially assigned values vary substantially from observed relationships between the biometric characteristic and generated health care-related costs.

In one implementation, a health care profile (e.g., a health care indexed value) is determined using a combination of a gaps in medical care metric (e.g., an aggregate indexed value for gaps in the individual's medical care) and a diagnosed medical condition metric (e.g., an aggregate indexed value for medical conditions diagnosed for the individual).

In one implementation, a health care profile (e.g., a health care indexed value) is determined using a combination of a gaps in medical care metric (e.g., an aggregate indexed value for gaps in the individual's medical care) and a medication possession ratio metric (e.g., an aggregate indexed value for the individual's medication possession ratio).

In one implementation, a health care profile (e.g., a health care indexed value) is determined using a combination of a gaps in medical care metric (e.g., an aggregate indexed value for gaps in the individual's medical care) and a prescribed medication metric (e.g., an aggregate indexed value for all medications prescribed to the individual).

In one implementation, a health care profile (e.g., a health care indexed value) is determined using a combination of a gaps in medical care metric (e.g., an aggregate indexed value for gaps in the individual's medical care) and a health care-related cost history metric (e.g., an aggregate indexed value for past medical costs generated by the individual).

In one implementation, a health care profile (e.g., a health care indexed value) is determined using a combination of a gaps in medical care metric (e.g., an aggregate indexed value for gaps in the individual's medical care) and a hospital visitation history metric (e.g., an aggregate indexed value for past visits to the hospital made by the individual).

In one implementation, a health care profile (e.g., a health care indexed value) is determined using a combination of a gaps in medical care metric (e.g., an aggregate indexed value for gaps in the individual's medical care) and a biometric characterization metric (e.g., an aggregate indexed value for biometric characteristics of the individual).

In one implementation, a health care profile (e.g., a health care indexed value) is determined using a combination of a gaps in medical care metric, a diagnosed medical condition metric, and a medication possession ratio metric.

In one implementation, a health care profile (e.g., a health care indexed value) is determined using a combination of a gaps in medical care metric, a diagnosed medical condition metric, and a prescribed medication metric.

In one implementation, a health care profile (e.g., a health care indexed value) is determined using a combination of a gaps in medical care metric, a diagnosed medical condition metric, and a health care-related cost history metric.

In one implementation, a health care profile (e.g., a health care indexed value) is determined using a combination of a gaps in medical care metric, a diagnosed medical condition metric, and a hospital visitation history metric.

In one implementation, a health care profile (e.g., a health care indexed value) is determined using a combination of a gaps in medical care metric, a diagnosed medical condition metric, and a biometric characterization metric.

In one implementation, a health care profile (e.g., a health care indexed value) is determined using a combination of a gaps in medical care metric, a medication possession ratio metric, and a prescribed medication metric.

In one implementation, a health care profile (e.g., a health care indexed value) is determined using a combination of a gaps in medical care metric, a medication possession ratio metric, and a health care-related cost history metric.

In one implementation, a health care profile (e.g., a health care indexed value) is determined using a combination of a gaps in medical care metric, a medication possession ratio metric, and a hospital visitation history metric.

In one implementation, a health care profile (e.g., a health care indexed value) is determined using a combination of a gaps in medical care metric, a medication possession ratio metric, and a biometric characterization metric.

In one implementation, a health care profile (e.g., a health care indexed value) is determined using a combination of a gaps in medical care metric, a prescribed medication metric, and a health care-related cost history metric.

In one implementation, a health care profile (e.g., a health care indexed value) is determined using a combination of a gaps in medical care metric, a prescribed medication metric, and a hospital visitation history metric.

In one implementation, a health care profile (e.g., a health care indexed value) is determined using a combination of a gaps in medical care metric, a prescribed medication metric, and a biometric characterization metric.

In one implementation, a health care profile (e.g., a health care indexed value) is determined using a combination of a gaps in medical care metric, a health care-related cost history metric, and a hospital visitation history metric.

In one implementation, a health care profile (e.g., a health care indexed value) is determined using a combination of a gaps in medical care metric, a health care-related cost history metric, and a biometric characterization metric.

In one implementation, a health care profile (e.g., a health care indexed value) is determined using a combination of a gaps in medical care metric, a hospital visitation history metric, and a biometric characterization metric.

In one implementation, a health care profile (e.g., a health care indexed value) is determined using a combination of a gaps in medical care metric, a diagnosed medical condition metric, a medication possession ratio metric, and a prescribed medication metric.

In one implementation, a health care profile (e.g., a health care indexed value) is determined using a combination of a gaps in medical care metric, a diagnosed medical condition metric, a medication possession ratio metric, and a health care-related cost history metric.

In one implementation, a health care profile (e.g., a health care indexed value) is determined using a combination of a gaps in medical care metric, a diagnosed medical condition metric, a medication possession ratio metric, and a hospital visitation history metric.

In one implementation, a health care profile (e.g., a health care indexed value) is determined using a combination of a gaps in medical care metric, a diagnosed medical condition metric, a medication possession ratio metric, and a biometric characterization metric.

In one implementation, a health care profile (e.g., a health care indexed value) is determined using a combination of a gaps in medical care metric, a diagnosed medical condition metric, a prescribed medication metric, and a health care-related cost history metric.

In one implementation, a health care profile (e.g., a health care indexed value) is determined using a combination of a gaps in medical care metric, a diagnosed medical condition metric, a prescribed medication metric, and a hospital visitation history metric.

In one implementation, a health care profile (e.g., a health care indexed value) is determined using a combination of a gaps in medical care metric, a diagnosed medical condition metric, a prescribed medication metric, and a biometric characterization metric.

In one implementation, a health care profile (e.g., a health care indexed value) is determined using a combination of a gaps in medical care metric, a diagnosed medical condition metric, a health care-related cost history metric, and a hospital visitation history metric.

In one implementation, a health care profile (e.g., a health care indexed value) is determined using a combination of a gaps in medical care metric, a diagnosed medical condition metric, a health care-related cost history metric, and a biometric characterization metric.

In one implementation, a health care profile (e.g., a health care indexed value) is determined using a combination of a gaps in medical care metric, a diagnosed medical condition metric, a hospital visitation history metric, and a biometric characterization metric.

In one implementation, a health care profile (e.g., a health care indexed value) is determined using a combination of a gaps in medical care metric, a medication possession ratio metric, a prescribed medication metric, and a health care-related cost history metric.

In one implementation, a health care profile (e.g., a health care indexed value) is determined using a combination of a gaps in medical care metric, a medication possession ratio metric, a prescribed medication metric, and a hospital visitation history metric.

In one implementation, a health care profile (e.g., a health care indexed value) is determined using a combination of a gaps in medical care metric, a medication possession ratio metric, a prescribed medication metric, and a biometric characterization metric.

In one implementation, a health care profile (e.g., a health care indexed value) is determined using a combination of a gaps in medical care metric, a medication possession ratio metric, a health care-related cost history metric, and a hospital visitation history metric.

In one implementation, a health care profile (e.g., a health care indexed value) is determined using a combination of a gaps in medical care metric, a medication possession ratio metric, a health care-related cost history metric, and a biometric characterization metric.

In one implementation, a health care profile (e.g., a health care indexed value) is determined using a combination of a gaps in medical care metric, a medication possession ratio metric, a hospital visitation history metric, and a biometric characterization metric.

In one implementation, a health care profile (e.g., a health care indexed value) is determined using a combination of a gaps in medical care metric, a prescribed medication metric, a health care-related cost history metric, and a hospital visitation history metric.

In one implementation, a health care profile (e.g., a health care indexed value) is determined using a combination of a gaps in medical care metric, a prescribed medication metric, a health care-related cost history metric, and a biometric characterization metric.

In one implementation, a health care profile (e.g., a health care indexed value) is determined using a combination of a gaps in medical care metric, a health care-related cost history metric, a hospital visitation history metric, and a biometric characterization metric.

In one implementation, a health care profile (e.g., a health care indexed value) is determined using a combination of a gaps in medical care metric, a diagnosed medical condition metric, a medication possession ratio metric, a prescribed medication metric, and a health care-related cost history metric.

In one implementation, a health care profile (e.g., a health care indexed value) is determined using a combination of a gaps in medical care metric, a diagnosed medical condition metric, a medication possession ratio metric, a prescribed medication metric, and a hospital visitation history metric.

In one implementation, a health care profile (e.g., a health care indexed value) is determined using a combination of a gaps in medical care metric, a diagnosed medical condition metric, a medication possession ratio metric, a prescribed medication metric, and a biometric characterization metric.

In one implementation, a health care profile (e.g., a health care indexed value) is determined using a combination of a gaps in medical care metric, a diagnosed medical condition metric, a medication possession ratio metric, a health care-related cost history metric, and a hospital visitation history metric.

In one implementation, a health care profile (e.g., a health care indexed value) is determined using a combination of a gaps in medical care metric, a diagnosed medical condition metric, a medication possession ratio metric, a health care-related cost history metric, and a biometric characterization metric.

In one implementation, a health care profile (e.g., a health care indexed value) is determined using a combination of a gaps in medical care metric, a diagnosed medical condition metric, a medication possession ratio metric, a hospital visitation history metric, and a biometric characterization metric.

In one implementation, a health care profile (e.g., a health care indexed value) is determined using a combination of a gaps in medical care metric, a diagnosed medical condition metric, a prescribed medication metric, a health care-related cost history metric, and a hospital visitation history metric.

In one implementation, a health care profile (e.g., a health care indexed value) is determined using a combination of a gaps in medical care metric, a diagnosed medical condition metric, a prescribed medication metric, a health care-related cost history metric, and a biometric characterization metric.

In one implementation, a health care profile (e.g., a health care indexed value) is determined using a combination of a gaps in medical care metric, a diagnosed medical condition metric, a health care-related cost history metric, a hospital visitation history metric, and a biometric characterization metric.

In one implementation, a health care profile (e.g., a health care indexed value) is determined using a combination of a gaps in medical care metric, a prescribed medication metric, a health care-related cost history metric, a hospital visitation history metric, and a biometric characterization metric.

In one implementation, a health care profile (e.g., a health care indexed value) is determined using a combination of a gaps in medical care metric, a medication possession ratio metric, a health care-related cost history metric, a hospital visitation history metric, and a biometric characterization metric.

In one implementation, a health care profile (e.g., a health care indexed value) is determined using a combination of a gaps in medical care metric, a medication possession ratio metric, a prescribed medication metric, a hospital visitation history metric, and a biometric characterization metric.

In one implementation, a health care profile (e.g., a health care indexed value) is determined using a combination of a gaps in medical care metric, a medication possession ratio metric, a prescribed medication metric, a health care-related cost history metric, and a biometric characterization metric.

In one implementation, a health care profile (e.g., a health care indexed value) is determined using a combination of a gaps in medical care metric, a medication possession ratio metric, a prescribed medication metric, a health care-related cost history metric, and a hospital visitation history metric.

In one implementation, a health care profile (e.g., a health care indexed value) is determined using a combination of a gaps in medical care metric, a medication possession ratio metric, a prescribed medication metric, a health care-related cost history metric, a hospital visitation history metric, and a biometric characterization metric.

In one implementation, a health care profile (e.g., a health care indexed value) is determined using a combination of a gaps in medical care metric, a diagnosed medical condition metric, a prescribed medication metric, a health care-related cost history metric, a hospital visitation history metric, and a biometric characterization metric.

In one implementation, a health care profile (e.g., a health care indexed value) is determined using a combination of a gaps in medical care metric, a diagnosed medical condition metric, a medication possession ratio metric, a health care-related cost history metric, a hospital visitation history metric, and a biometric characterization metric.

In one implementation, a health care profile (e.g., a health care indexed value) is determined using a combination of a gaps in medical care metric, a diagnosed medical condition metric, a medication possession ratio metric, a prescribed medication metric, a hospital visitation history metric, and a biometric characterization metric.

In one implementation, a health care profile (e.g., a health care indexed value) is determined using a combination of a gaps in medical care metric, a diagnosed medical condition metric, a medication possession ratio metric, a prescribed medication metric, a health care-related cost history metric, and a biometric characterization metric.

In one implementation, a health care profile (e.g., a health care indexed value) is determined using a combination of a gaps in medical care metric, a diagnosed medical condition metric, a medication possession ratio metric, a prescribed medication metric, a health care-related cost history metric, and a hospital visitation history metric.

In one implementation, a health care profile (e.g., a health care indexed value) is determined using a combination of a gaps in medical care metric, a diagnosed medical condition metric, a medication possession ratio metric, a prescribed medication metric, a health care-related cost history metric, a hospital visitation history metric, and a biometric characterization metric.

The foregoing description, for purpose of explanation, has been described with reference to specific implementations. However, the illustrative discussions above are not intended to be exhaustive or to limit the disclosed implementations to the precise forms disclosed. Many modifications and variations are possible in view of the above teachings. The implementations were chosen and described in order to best explain the principles and practical applications of the disclosed ideas, to thereby enable others skilled in the art to best utilize them with various modifications as are suited to the particular use contemplated.

It will be understood that, although the terms “first,” “second,” etc. may be used herein to describe various elements, these elements should not be limited by these terms. These terms are only used to distinguish one element from another. For example, a first health care characteristic could be termed a second health care characteristic, and, similarly, a second health care characteristic could be termed a first health care characteristic, without changing the meaning of the description, so long as all occurrences of the “first health care characteristic” are renamed consistently and all occurrences of the “second health care characteristic” are renamed consistently. The first health care characteristic and the second health care characteristic are both health care characteristics, but they are not the same health care characteristic.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method for assigning an individual to a stratum associated with a risk of generating a high level of health care-related costs, the method comprising:
at an electronic device comprising a processor and memory storing instructions for execution by the processor:
receiving information on the diagnosis of a medical condition for the individual;
identifying a gap in the individual's medical care for the diagnosed medical condition;
associating the gap in medical care with an indexed value related to the severity of the gap in care; and
assigning the individual to one of a plurality of strata based on a health care profile of the individual, the health care profile comprising the indexed value related to the severity of the gap in care.

2. The method of claim 1, wherein the information on the diagnosis of a medical condition includes one or more of: a date on which the diagnosis was initially made, dates of medical consultations occurring after the date on which the diagnosis was initially made, an estimated date on which the diagnosed medical condition began, a date of the medical consultation immediately preceding the date on which the diagnosis was initially made.

3. The method of claim 1, wherein the gap in care is identified by one or more of: determining a period of time between a first medical consultation and a second medical consultation that is longer than a recommended period of time between medical consultations, the recommended period of time being specific to the diagnosed medical condition, determining a gap in time between the estimated date on which the diagnosed medical condition began and the date on which the diagnosis was initially made, determining a period of time, after the date on which the diagnosis was initially made, where the individual did not have a valid prescription for a recommended course of therapy, the recommended course of therapy being specific to the diagnosed medical condition, and determining a period of time, after an estimated date on which the diagnosed medical condition began, where the individual did not have a valid prescription for a recommended course of therapy, the recommended course of therapy being specific to the diagnosed medical condition.

4. The method of claim 1, wherein the indexed value related to the severity of the gap in care includes a first component specific to the diagnosed medical condition and a second component specific to the length of the gap in the individual's medical care.

5. The method of claim 1, wherein:
the plurality of strata includes a first stratum, associated with a low risk of generating a high level of healthcare-related costs, and a second stratum, associated with a high risk of generating a high level of healthcare-related costs;
the individual's health care profile is a health care indexed value including the indexed value related to the severity of the gap in care as a component; and
the individual is assigned to the second stratum if the individual's health care indexed value is above a threshold value.

6. The method of claim 5, wherein the threshold value is a predetermined threshold value or relative to a set of health care indexed values corresponding to a set of individuals in which the individual belongs.

7. The method of claim 1, wherein the health care profile of the individual further comprises an indexed value related to one or more of a diagnosed medical condition, a medication possession ratio, a prescribed medication, a history of generating a high level of health care-related costs, a history of hospital visitations, and a biometric characteristic.

8. The method of claim 7, wherein the health care profile of the individual includes one of:
(a) indexed values related to the severity of the gap in care and a diagnosed medical condition;
(b) indexed values related to the severity of the gap in care and a medication possession ratio;
(c) indexed values related to the severity of the gap in care and a prescribed medication;
(d) indexed values related to the severity of the gap in care and a history of generating a high level of health care-related costs;
(e) indexed values related to the severity of the gap in care and a history of hospital visitations;
(f) indexed values related to the severity of the gap in care and a biometric characteristic;
(g) indexed values related to the severity of the gap in care, a diagnosed medical condition, and a medication possession ratio;
(h) indexed values related to the severity of the gap in care, a diagnosed medical condition, and a history of generating a high level of health care-related costs; and
(i) indexed values related to the severity of the gap in care, a diagnosed medical condition, and a biometric characteristic.

9. The method of claim 8, wherein:
the indexed value related to a diagnosed medical condition is a sum of individual condition risk factors, each respective condition risk factor being specific to a medical condition diagnosed for the individual;
the combination risk factor being specific to the combination of medical conditions diagnosed for the individual;
the indexed value related to a prescribed medication includes a first component specific to a risk posed by a particular medication prescribed to the individual;
the indexed value related to a prescribed medication includes a second component specific to the total number of medications prescribed to the individual;
the indexed value related to a prescribed medication includes a third component specific to a risk posed by a particular combination of drugs prescribed to the individual; or
the indexed value related to a history of hospital visitations includes components for hospital admissions, hospital readmissions, and emergency room visits made by the individual;

10. The method of claim 1, wherein the health care profile is a health care indexed value determined using a learned algorithm.

11. A method for assigning individuals in a set of individuals to a stratum associated with a risk of generating a high level of health care-related costs, the method comprising:
at an electronic device comprising a processor and memory storing instructions for execution by the processor:
receiving a plurality of medical histories, each medical history in the plurality of medical histories corresponding to an individual in the set of individuals, wherein respective medical histories in the plurality of medical histories include information on the diagnosis of a medical condition for the corresponding individual;
identifying gaps in the medical care of respective individuals for their corresponding medical conditions;
associating each respective gap in medical care with an indexed value related to the severity of the respective gap in medical care; and
assigning respective individuals in the set of individuals to one of a plurality of strata based on corresponding health care profiles, each respective health care profile comprising an indexed value related to the severity of the respective gap in care.

12. The method of claim 11, wherein the information on the diagnosis of a medical condition includes one or more of: a date on which the diagnosis was initially made, dates of medical consultations occurring after the date on which the diagnosis was initially made; an estimated date on which the diagnosed medical condition began, and a date of the medical consultation immediately preceding the date on which the diagnosis was initially made.

13. The method of claim 11, wherein respective gaps in care are identified by one or more of: determining periods of time between a first medical consultation and a second medical consultation that is longer than a recommended period of time between medical consultations, the recommended period of time being specific to the corresponding diagnosed medical condition, determining gaps in time between an estimated date on which a diagnosed medical condition began and the date on which the diagnosis was initially made, determining periods of time, after a date on which a diagnosis was initially made, where the corresponding individual did not have a valid prescription for a recommended course of therapy, the recommended course of therapy being specific to the diagnosed medical condition, and determining periods of time, after an estimated date on which a diagnosed medical condition began, where the corresponding individual did not have a valid prescription for a recommended course of therapy, the recommended course of therapy being specific to the diagnosed medical condition.

14. The method of claim 11, wherein each indexed value related to the severity of a gap in care includes a first component specific to a diagnosed medical condition and a second component specific to a length of the gap in the corresponding individual's medical care.

15. The method of claim 11, wherein the health care profile of each respective individual further comprises an indexed value related to one or more of a diagnosed medical condition, a medication possession ratio, a prescribed medication, a history of generating a high level of health care-related costs, a history of hospital visitations, and a biometric characteristic.

16. The method of claim 11, wherein each respective health care profile is a health care indexed value determined using a learned algorithm.

17. The method of claim 11, further comprising:
after assigning individuals to one of a plurality of strata, tracking health care related costs accrued for respective individuals in the set of individuals for a period of time;
adjusting a parameter used to determine the health care profiles of respective individuals in the set of individuals based on the health care costs accrued during the period of time;
and re-assigning respective individuals in the set of individuals to one of a plurality of strata based on a health care profile of the respective individual, the health care profile comprising the adjusted parameter.

18. The method of claim 11, further comprising:
allocating medical resources based on the assignment of individuals into a stratum associated with a high risk of generating a high level of healthcare-related costs.

19. The method of claim 18, wherein the medical resources include a medical outreach program or feedback to respective individuals based on their corresponding health care profile or a component D.

20. A computer readable storage medium storing one or more programs, the one or more programs comprising instructions, which when executed by an electronic device, cause the device to perform the method of claim 1.
